(19) United States
(12) Patent Application Publication
(10) Pub. No.: US 2025/0181901 A1
(43) Pub. Date: Jun. 5, 2025

(54) BIOLOGICALLY INSPIRED SLEEP-LIKE PROCESS FOR ENHANCING ARTIFICIAL NEURAL NETWORKS

(71) Applicant: THE REGENTS OF THE UNIVERSITY OF CALIFORNIA, Oakland, CA (US)

(72) Inventors: Jean Erik DELANOIS, San Diego, CA (US); Giri P. KRISHNAN, Socorro, NM (US); Maksim BAZHENOV, San Diego, CA (US)

(21) Appl. No.: 19/043,154

(22) Filed: Jan. 31, 2025

Related U.S. Application Data
(63) Continuation-in-part of application No. 18/981,304, filed on Dec. 13, 2024.
Application No. 18/981,304 is a continuation-in-part of application No. 17/627,092, filed on Jan. 13, 2022.
(60) Provisional application No. 62/875,444, filed on Jul. 17, 2019.

(51) Int. Cl. G06N 3/049

(52) U.S. Cl. CPC G06N 3/049

(57) ABSTRACT

An example method of the presently disclosed technology may include: (1) transforming a neural network from an artificial neural network (ANN) to a spiking neural network (SNN); (2) when the neural network is transformed into the SNN, modifying synaptic weights of the neural network by applying a simulated memory replay process to the neural network; and (3) after applying the simulated memory replay process to the neural network, transforming the neural network from the synaptic weight-modified SNN to a synaptic weight-modified ANN.

### REFERENCE TO RELATED APPLICATIONS

The present application is a continuation-in-part of U.S. patent application Ser. No. 18/981,304, filed Dec. 13, 2024 and titled “BIOLOGICALLY INSPIRED SLEEP-LIKE OPTIMIZATION FOR NEURAL NETWORKS”, which is a continuation-in-part of U.S. patent application Ser. No. 17/627,092, filed Jan. 13, 2022 and titled “BIOLOGICALLY INSPIRED SLEEP ALGORITHM FOR ARTIFICIAL NEURAL NETWORKS”, which is the U.S. National Stage of International Patent Application No. PCT/US2020/042686, filed Jul. 17, 2020 and titled “BIOLOGICALLY INSPIRED SLEEP ALGORITHM FOR ARTIFICIAL NEURAL NETWORKS”, which claims the benefit of U.S. Provisional Application No. 62/875,444, filed Jul. 17, 2019 and titled “BIOLOGICALLY INSPIRED SLEEP ALGORITHM FOR ARTIFICIAL NEURAL NETWORKS,” all of which are incorporated herein by reference in their entirety.

### STATEMENT REGARDING FEDERALLY SPONSORED R&D

This invention was made with government support under Grant No. 1R01MH125557 awarded by the National Institutes of Health (NIH), and Grant No. 2223839 awarded by the National Science Foundation (NSF). The government has certain rights in the Invention.

### TECHNICAL FIELD

The present disclosure is generally related to neural networks and machine learning. More specifically, some implementations relate to converting an artificial neural network (ANN) into a spiking neural network (SNN) and simulating unsupervised sleep-like replay in the SNN.

### DESCRIPTION OF RELATED ART

Over the past few decades, computer science has made remarkable advancements in the development of neural network models capable of performing intricate tasks. Deep learning, in particular, has played a pivotal role in driving this progress. Generally, the performance of deep learning methods has been correlated with the size and/or quality of training datasets. For example, deep learning methods have shown considerable performance when trained with large, balanced datasets.

### BRIEF DESCRIPTION OF THE DRAWINGS

Various embodiments are disclosed herein and described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 provides an example implementation and evaluation of the sleep algorithm, in accordance with various embodiments of the present disclosure.

FIG. 1A is an example illustration of a “Patches” dataset with 4 images with 15 pixel overlap among the images, in accordance with various embodiments of the present disclosure.

FIG. 1B illustrates an example graph of the accuracy of trained tasks after training and sleep phases, in accordance with various embodiments of the present disclosure.

FIG. 1C illustrates the same as FIG. 1B with only one sleep phase, in accordance with various embodiments of the present disclosure.

FIG. 1D illustrates an example bar graph comparing the spread of the weights connecting from on-pixels to output neurons vs. off-pixels, in accordance with various embodiments of the present disclosure.

FIG. 1E illustrates an example graph of the accuracy as a function of number of overlapping pixels at different points in training, in accordance with various embodiments of the present disclosure.

FIG. 1F illustrates the same as FIG. 1D but with one final sleep phase, in accordance with various embodiments of the present disclosure.

FIG. 2 illustrates an example implementation and evaluation of the sleep algorithm on MNIST and CUB200 datasets, in accordance with various embodiments disclosure.

FIG. 2A illustrates an example graph of the accuracy for each of the 5 tasks and overall as a function of training phases, in accordance with various embodiments of the present disclosure.

FIG. 2B illustrates an example confusion matrix after the first awake and sleep phases, in accordance with various embodiments of the present disclosure.

FIG. 2C illustrates the same as FIG. 2B but after last training and sleep phases, in accordance with various embodiments of the present disclosure.

FIG. 2D illustrates an example summary MNIST performance graph comparing sleep vs a simple fully connected network, in accordance with various embodiments of the present disclosure.

FIG. 2E illustrates an example summary CUB2000 performance graph depicting the accuracy of trained tasks after training and sleep phases, in accordance with various embodiments of the present disclosure.

FIG. 3 illustrates example correlation graphs demonstrating sleep decreases representational overlap between MNIST classes at all layers, in accordance with various embodiments of the present disclosure.

FIG. 3A illustrates an example graph of the average correlations of activations in the first hidden layer for each digit, in accordance with various embodiments of the present disclosure.

FIG. 3B illustrates the same as FIG. 3A except correlations are computed in the output layer, in accordance with various embodiments of the present disclosure.

FIG. 4 provides an example implementation and evaluation of the sleep algorithm in MNIST and Patches datasets, in accordance with various embodiments of the present disclosure.

FIG. 4A illustrates an example graph depicting the performance of the sleep algorithm in classifying degraded images for the MNIST dataset, in accordance with various embodiments of the present disclosure.

FIG. 4B illustrates the same as FIG. 4A for the Patches dataset, in accordance with various embodiments of the present disclosure.

FIG. 4C illustrates an example confusion matrix before and after sleep for low noise and blue for the MNIST dataset, in accordance with various embodiments of the present disclosure.

FIG. 4D illustrates a confusion matrix before and after sleep for low noise and blue for the Patches dataset, in accordance with various embodiments of the present disclosure.

FIG. 5 illustrates an example implementation and evaluation of the sleep algorithm exposed to adversarial attacks, in accordance with various embodiments of the present disclosure.

FIG. 5A illustrates an example graph depicting the performance of the sleep algorithm on classifying images with various amounts of distortion in a Patches dataset, as caused by a single adversarial attack, in accordance with various embodiments of the present disclosure.

FIG. 5B illustrates an example graph depicting the performance of the sleep algorithm on classifying images with various amounts of distortion in a MNIST dataset, as caused by a single adversarial attack, in accordance with various embodiments of the present disclosure.

FIG. 5C illustrates an example graph depicting the performance of the sleep algorithm on classifying images with various amounts of distortion in a CUB200 dataset, as caused by a single adversarial attack, in accordance with various embodiments of the present disclosure.

FIG. 6 illustrates an example computing component that may be used to implement features of various embodiments of the present disclosure.

FIG. 7 illustrates example images depicting distortions applied to a MNIST image classification data set used to test example algorithms, in accordance with various embodiments of the presently disclosed technology.

FIG. 8 illustrates example images depicting distortions applied to a CIFAR10 image classification data set used to test example Sleep Replay Consolidation (SRC) algorithms, in accordance with various embodiments of the presently disclosed technology.

FIG. 9 illustrates an example table that shows network parameters used for applying example SRC algorithms to the MNIST and CIFAR10 image classification data sets, in accordance with various embodiments of the presently disclosed technology.

FIG. 10 illustrates an example table that shows hyperparameters used for example SRC algorithms, in accordance with various embodiments of the presently disclosed technology.

FIG. 11 illustrates example graphs depicting accuracy vs distortion intensity for different methods applied to the MNIST dataset, in accordance with various embodiments of the presently disclosed technology.

FIG. 12 illustrates example graphs depicting accuracy vs distortion intensity for different methods applied to the CIFAR10 dataset, in accordance with various embodiments of the presently disclosed technology.

FIG. 13 illustrates an example table showing model performance of various methods on the MNIST dataset, in accordance with various embodiments of the presently disclosed technology.

FIG. 14 illustrates an example table showing model performance of various methods on the CIFAR10 dataset, in accordance with various embodiments of the presently disclosed technology.

FIG. 15 illustrates an example table showing mean and standard deviation of spatial gradient variance across various models, in accordance with various embodiments of the presently disclosed technology.

FIG. 16 illustrates an example table showing KL divergence values between a baseline and various models, in accordance with various embodiments of the presently disclosed technology.

FIG. 17 illustrates an example table showing Grad-CAM visualizations for the MNIST dataset that display the attention quality for a baseline and SRC, in accordance with various embodiments of the presently disclosed technology.

FIG. 18 illustrates example images depicting Grad-CAM visualizations for the CIFAR10 dataset that display the attention quality for a baseline and SRC, in accordance with various embodiments of the presently disclosed technology.

FIG. 19 illustrates example images depicting hyper parameters for Gradient expansion for results for the first and second convolution layer respectively, in accordance with various embodiments of the presently disclosed technology.

FIG. 20 illustrates an example table depicting Grad-CAM of the attention overlap metric for various methods, in accordance with various embodiments of the presently disclosed technology.

FIG. 21 illustrates an example algorithm for converting a CNN into an SNN and simulating unsupervised replay in the SNN, in accordance with various embodiments of the presently disclosed technology.

FIG. 22 illustrates an example method for converting a CNN into an SNN and simulating unsupervised replay in the SNN, in accordance with various embodiments of the presently disclosed technology.

FIG. 23 illustrates is an example computing component that may be used to implement various features of embodiments described in the present disclosure.

FIG. 24 illustrates an example graph depicting accuracy of neural networks vs fraction of total MNIST training data used to train the neural networks, in accordance with various embodiments of the presently disclosed technology.

FIG. 25 illustrates an example graph depicting accuracy of neural networks vs fraction of total FMNIST training data used to train the neural networks, in accordance with various embodiments of the presently disclosed technology.

FIG. 26 illustrates an example confusion matrix of a neural network trained with a MNIST dataset before a sleep process is applied to the neural network, in accordance with various embodiments of the presently disclosed technology.

FIG. 27 illustrates an example confusion matrix of a neural network trained with a MNIST dataset after a sleep process is applied to the neural network, in accordance with various embodiments of the presently disclosed technology.

FIG. 28 illustrates an example confusion matrix of a neural network trained with a FMNIST dataset before a sleep process is applied to the neural network, in accordance with various embodiments of the presently disclosed technology.

FIG. 29 illustrates an example confusion matrix of a neural network trained with a FMNIST dataset after a sleep process is applied to the neural network, in accordance with various embodiments of the presently disclosed technology.

FIG. 30 illustrates an example graph depicting accuracy of a neural network trained with varying amounts of data for certain classes of a MNIST dataset before and after applying a sleep process to the neural network, in accordance with various embodiments of the presently disclosed technology.

FIG. 31 illustrates an example graph depicting layer-wise activity of a neural network, trained with a MNIST dataset, during the application of a sleep process, in accordance with various embodiments of the presently disclosed technology.

FIG. 32 illustrates an example graph depicting layer-wise activity of a neural network, trained with a FMNIST dataset, during the application of a sleep process, in accordance with various embodiments of the presently disclosed technology.

FIG. 33 illustrates an example graph depicting weight difference distributions of a neural network, trained with a MNIST dataset, after the application of a sleep process, in accordance with various embodiments of the presently disclosed technology.

FIG. 34 illustrates an example graph depicting weight difference distributions of a neural network, trained with a FMNIST dataset, after the application of a sleep process, in accordance with various embodiments of the presently disclosed technology.

FIG. 35 illustrates an example method for converting an ANN into an SNN and simulating unsupervised replay in the SNN, in accordance with various embodiments of the presently disclosed technology.

FIG. 36 illustrates an example computing component that may be used to implement various features of embodiments described in the present disclosure.

The figures are not exhaustive and do not limit the present disclosure to the precise form disclosed.

### DETAILED DESCRIPTION

Although artificial neural networks (ANNs) have equaled and even surpassed human performance on various tasks, they nevertheless still suffer from a range of intrinsic limitations. To start, ANNs suffer from catastrophic forgetting. That is, while humans and animals can continuously learn from new information, ANNs perform well on new tasks while forgetting older tasks that are not explicitly retrained. Next, ANNs fail to generalize to multiple examples of the specific task for which ANNs were trained. The second limitation is tied to the sample data that is used to build a mathematical model or computational algorithm. Specifically, ANNs are usually trained with highly filtered datasets, which often constricts the extent to which the generated neural network can generalize beyond these filtered datasets (i.e., examples). In contrast, humans frequently form unrestricted generalizations based on the presence of limited and/or altered stimulus conditions. Lastly, related but also distinct from the second limitation, ANNs sometimes fail to transfer learning to other similar tasks apart from the ones they were explicitly trained on. Whereas humans can represent information in a generalized fashion that does not depend on the exact properties or conditions of how they learned the task. This ability allows the mammalian brain (e.g., humans) to transfer old knowledge to unlearned tasks, while the current state of deep learning models are unable to do so.

Sleep has been hypothesized to play an important role in memory consolidation and generalization of knowledge. During sleep, neurons are spontaneously active without external input and generate complex patterns of synchronized oscillatory activity across brain regions. Previously experienced or learned activity is believed to be replayed during sleep. This replay of the recently learned memories along with relevant old memories is thought to be the critical mechanism that results in memory consolidation. Accordingly, it would be highly desirable to adopt the main processes behind sleep activity to benefit ANNs performance based on the relevant biophysical models.

The principles of memory consolidation during sleep have conventionally been used to address the problem of catastrophic forgetting in ANNs. Several relevant instances include a generative model of the hippocampus and cortex to generate examples from a distribution of previously learned tasks in order to retrain (replay) these tasks during a sleep phase; generative algorithms to generate previously experienced stimuli during the next training period; and a loss function (termed elastic weight consolidation—EWC), which penalizes updates to weights deemed appropriate for previous tasks, made use of synaptic mechanisms of memory consolidation. Although these instances report positive results in preventing catastrophic forgetting, they also have associated limitations. First, EWC does not seem to work in an incremental learning framework. Second, generative models generally focus on the replay aspect of sleep; as such, it is unclear if these models could have potential benefits in addressing problems of generalization of knowledge. Further, generative models require a separate network that stores the statistics of previously learned inputs which imposes an additional cost, while rehearsal of small examples of different classes may be sufficient to prevent catastrophic forgetting.

The presently disclosed technology provides a sleep-inspired algorithm that makes use of two principles observed during sleep in biology: memory reactivation and synaptic plasticity. In one example, ANN is trained first using backpropagation algorithm. However, it should be appreciated that any other training algorithms can be applied to train ANN. After initial training, denoted awake training, the ANN is converted to a spiking neural network (SNN). In one example, unsupervised spike-timing-dependent plasticity (STDP) phase with noisy input and increased intrinsic network activity is performed to represent sleep up-states-dynamics found in deep sleep. However, it should be appreciated that any other plasticity rules can be applied to SNN during sleep phase and any other modifications can be applied to the network to simulate sleep phase. Finally, the weights from the SNN are converted back into the ANN and performance tested. The presently disclosed technology demonstrates a myriad of benefits by incorporating a sleep algorithm. For example, sleep reduces catastrophic forgetting by reactivation of older tasks, sleep increases the network's ability to generalize to noisy versions of the training set, and sleep allows the network to perform forward transfer learning.

The presently disclosed technology provides the first known sleep-like algorithm that improves ANNs ability to generalize on noisy versions of the input. Furthermore, the presently disclosed technology is more scalable, does not require memory storage of the previously seen inputs, and ultimately demonstrates that ANNs retain information about forgotten tasks that could be reactivated through sleep. The presently disclosed technology could be complimentary to previous approaches and, importantly, it provides a principled way to incorporate various features of sleep to wide range of neural network architectures.

### A. Sleep Algorithm Approach to Machine Learning

In several embodiments, the general components of the sleep algorithm may include any class of ANN network trained on some task. This algorithm is applicable to any ANN with any form of connectivity (feedforward and recurrent). The ANN network is first converted to SNN. In one example, a previously developed algorithm is incorporated to convert the architecture in the feedforward network (FCN) (i.e., ANN) to an equivalent SNN. However, it should be appreciated that other algorithms may be used to convert the ANN to an equivalent SNN. In one example, the weights from an ANN with ReLU activation units are transferred directly to the SNN, which consists of leaky integrate-and-fire neurons and the weights are scaled by the maximum activation in each layer during training. Any other types of neurons and other modifications to the weights can be applied to obtain a desirable SNN. After building the SNN, a ‘sleep’ phase is applied which modifies the network connectivity. After running sleep phase, the weights are converted back into the ANN and testing or further training is performed.

Below, the details of the example implementation of the sleep phase are described in more detail. It should be noted that in other implementations, other changes can be applied to the weights, other inputs can be applied to the input layer, other spiking neuronal models can be utilized and other plasticity rules can be used to modify weights. In one example implementation, the input layer in the SNN is represented as a Poisson-distributed spike train with mean firing rate given by the average value of that unit in the ANN for all tasks seen so far. However, it should be appreciated that other inputs, including but not limited to the random input, or no input at all, can be applied. Either the entire average image seen so far (used for initial ANN training) or randomized portions of the average image seen so far or all the active regions during any of the inputs is presented. In one example, Spike Timing Dependent Plasticity (STDP) rule was applied to SNN. However, it should be appreciated that other plasticity rules, including but not limited to different versions of Hebbian or BCM rules, can be applied. To apply STDP, a one timestep of the network propagating activity is ran. Each layer has 2 important parameters that dictates its firing rate: a threshold and a synaptic scaling factor. The input to a neuron is computed as aW\dot{x}, where a is the layer-specific synaptic scaling factor, W is the weight matrix, and x is the spiking activity (binary) of the previous layer. This input is added to the neuron's membrane potential. If the membrane potential exceeds a threshold, the neuron fires a spike and its membrane potential is reset. Otherwise, the potential decays exponentially. After each spike, weights are updated according to a modified sigmoidal weight-dependent STDP rule. Weights are increased if a pre-synaptic spike leads to a post-synaptic spike. Weights are decreased if a post-synaptic spike fires without a pre-synaptic spike.

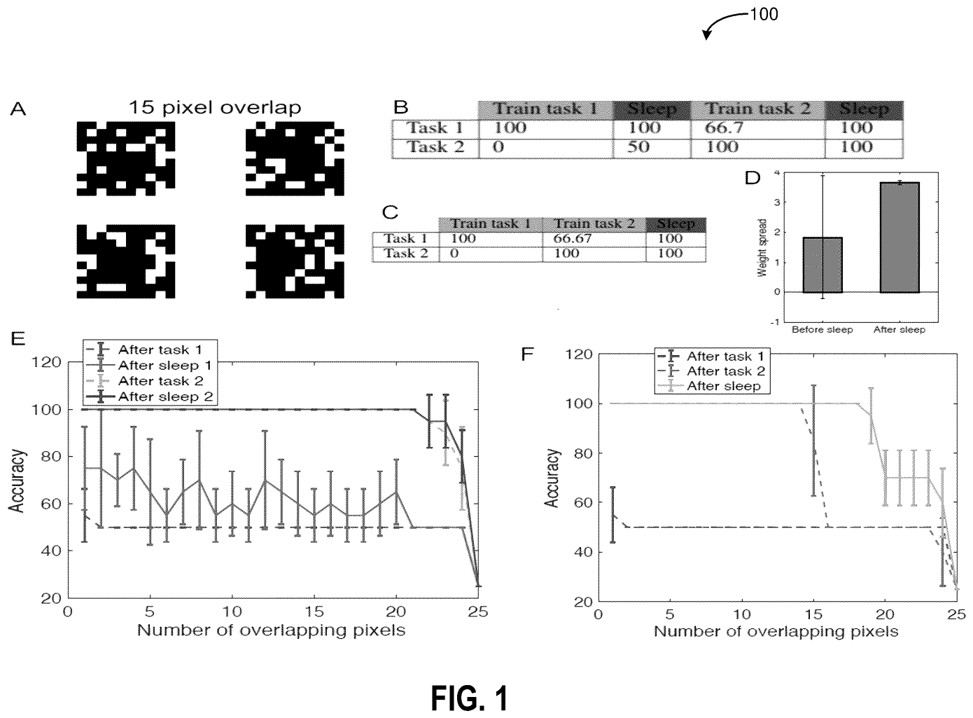

In embodiments, the sleep algorithm was tested on various datasets, including a toy datasets which was used as a motivating example. The toy dataset, termed “Patches”, consists of 4 images of binary pixels arranged in an N×N matrix (As shown in FIG. 1A). Each of the images has varying amount of overlap with the other 4 images to test catastrophic forgetting. Likewise, the patches are blurred so that on-pixels spillover into neighboring pixels making the dataset slightly different from the one the network was trained on. This dataset was utilized to show the benefits of the sleep algorithm in a simpler setting. The sleep algorithm was also tested on the MNIST and CUB200 datasets to ensure generalizability. For CUB200, the pre-trained Resnet embeddings previously used for catastrophic forgetting was applied.

To test catastrophic forgetting, an example incremental learning framework was utilized. The FCN was trained sequentially on groups of 2 classes for patches and MNIST and groups of 100 classes for CUB200. After training on a single task, the sleep algorithm was run as previously described before training on the next task. To test generalization, the FCN was trained on the entire dataset and compared this network's performance on classifying noisy or blurred images to the FCN that underwent sleep phase after training. Regarding transfer learning, a network trained on one task, when put to sleep, improves performance on a new, unseen task. Dataset specific parameters for training and sleep in the catastrophic forgetting task are shown in Table 1 (See below). For the MNIST dataset, a genetic algorithm to find optimal parameters was utilized, although this is not necessary and the summary results are based on hand-tuned parameters.

TABLE 1
Approximate description of parameters
used in each of the 3 datasets.

| | Patches | MNIST | CUB200 |
|---|---|---|---|
| Architecture | [100, 4] | [784, 500, 500, 10] | [2048, 350, 300, 200] |
| Learning | 0.1 | 0.065 | 0.1, 0.01 |
| Rate | | | |
| Dropout | 0 | 0.2 | 0.25 |
| Epochs | 1 per | 2 per | 50 per |
| | task | task | task |
| Input Rate | 64 Hz | 130 Hz | 32 Hz |
| Thresholds | 1.045 | 2.1772, 1.5217, 0.9599 | 1, 1, 1 |
| Synaptic | 4.25 | 3.4723, 25.52, 2.4186 | 1, 1, 1 |
| Increase | 0.0035 | 0.0197 | 0.01 |
| factor | | | |
| Decrease | 0.0002 | 0.0016 | 0.001 |
| factor | | | |

### B. Sleep Algorithm Advantages and Verified Examples

### 1) Sleep Prevents Catastrophic Forgetting and May Lead to Forward Transfer

FIG. 1 illustrates an example implementation and evaluation 100 of the presently disclosed technology. Notably, the results demonstrate the improved performance in network recall provided by applying mechanisms of biological sleep in memory consolidation to existing artificial intelligence architectures. To start, FIG. 1A depicts a Patches dataset and represents an easily interpretable example to verify and validate the presently disclosed technology. In this example, 4 binary images of size 10×10 with 15 pixel overlap and 25% of pixels turned on are utilized. Thus, 10 pixels are unique amongst each image in the dataset. To determine if catastrophic forgetting occurs, and if sleep can recover performance, the dataset is split into two tasks-one task representing two images and the other task comprised of the other two images. Training on task 1 resulted on high performance on task 1 with no performance on task 2. After a sleep phase, performance on task 1 remained perfect, while task 2 performance sometimes revealed an increase. After training on task 2, performance on task 1 on average decreased from its perfect level, indicating forgetting of task 1. However, after sleep performance on both task 1 and task 2 was maximized at 100% (FIG. 1B). Including only one sleep phase at the end of awake training also resurrected performance on both tasks (FIG. 1C).

To analyze how sleep prevents catastrophic forgetting in this toy dataset example, in some embodiments the weights connecting to each input neuron were assessed. Since knowledge of all pixels in the dataset is known, the weights connecting from pixels that are turned on in an image to the corresponding output neuron are measured. Ideally, for a given image, the spread between weights from on-pixels and weights from off-pixels should be high, such that on-pixels drive an output neuron and off-pixels suppress the same output neuron. To measure this, the average is computed spread across output neurons and weights for on-pixels and off-pixels (FIG. 1D). The results indicate that sleep increases the spread between weights connecting from on-pixels and off-pixels, validating the sleep algorithm is working correctly by increasing meaningful weights and decreasing potentially irrelevant or incorrect weights. Next, the performance was observed as a function of the number of overlapping pixels in the dataset for 2 cases: one with sleep after each awake training period and one with only one sleep at the end of training. With 2 sleep phases, after the first sleep, the network performs well on the first task and correctly classifies images from the second task about 50% of the time (FIG. 1E). This suggests that sleep increased performance on tasks for which the SNN has not seen any training input. An improvement on unseen future tasks is denoted as ‘forward transfer’ similar to zero-shot learning phenomenon previously shown in other architectures.

After training on the second task followed by sleep, the network may classify all the images correctly up to the very high level of pixel overlap. In the last case, it is observed that the sleep phase increases performance beyond that of the control network, indicating less catastrophic forgetting (FIG. 1F). Forgetting only occurs at a pixel overlap greater than 15 pixels. However, at higher pixel overlap values, sleep routinely reduces the amount of forgetting. Comparing the two cases, it is noted that an intermediate sleep phase between task one and task two actually increases performance and reduces forgetting after normal awake training on task two. This suggests that sleep may be useful in creating a forward transfer representation of similar, yet discrete, tasks and may boost transfer learning in other domains. Overall, these results validate the sleep algorithm and the same results may be obtained for more complex datasets.

### 2) Analysis of the Role of Sleep to Prevent Catastrophic Forgetting

A simple case study is now presented to examine the cause of catastrophic failure and the role of sleep in recovering from it. While this example is not intended to model all scenarios of catastrophic forgetting, it extracts the intuition and explains the basic mechanism of the presently disclosed technology.

First, image a 3-layer network trained on two categories, each with just one example. Consider 2 binary vectors (Category 1 and Category 2) with some region of overlap.

For ReLU activations, the output is deemed to be the neuron with the highest activation in the output layer. Let the network be trained on Category 1 with backpropagation with a static learning rate. Following this, the network is trained on Category 2 in an equivalent fashion. The 3-layer network considered had had an input layer with 10 neurons, 30 hidden neuron and an output layer with 2 neurons for the 2 categories. Inputs were 10 bits long with 5 bit overlap. The learning rate of 0.1 for 4 epochs is trained.

The hidden neurons are divided into four types based on their activation for the two categories: A—those neurons that fire on Category 1 but not 2; B—those neurons that fire on Category 2 but not 1; C—those neurons that fire on Category 1 and 2; D—those that fire on neither, where firing indicates a non-zero activation. Note that these sets may change on training or sleep. Let Xi be the weights from type X to output i.

Consider the case where input of Category 1 is presented. The only hidden layer neurons that fire are A and C. Output neuron 1 will get the net value A*A1+C*C1 and output neuron 2 will get the net value A*A2+C*C2. For output neuron 1 to fire, two conditions need to hold: (1) A*A1+C*C1>0(2)A*A1+C*C1>A*A2+C*C2. The second condition above can be rewritten as A*A2−A*A1<C*C1−C*C2, which separates the weights according to hidden neurons. Using this separation, the following definitions were utilized: Define a to be (A2−A1)*A on pattern 1; b to be (A2−A1)*A on pattern 2; p to be (C1−C2)*C on pattern 1 and q to be (C1−C2)*C on pattern 2. (Note that p and q are very closely correlated since they differ only in the activation values of C neurons which are positive in both cases).

So, on input pattern 1, output 1 fires only if a<p; on input pattern 2, output 2 fires only if q<b.

Following training on 2 categories, if the network could not recall Category 1, i.e., output neuron I's activation is negative or less than that of output neuron 2, catastrophic forgetting has occurred. The second phase of training ensures q<b. This could involve reduction in q which would reduce p as well. (Since A does not fire on input pattern 2, back-propagation does not alter a) Reducing p may result in failing the condition a<p, i.e., misclassifying input 1.

Sleep may increase the difference in the weights (which are different enough to begin with) in this case as shown in previous work. So, the difference between A2 and A1 increases, this decreasing a (as A1 is higher, a−A2−A1 decreases). The same thing happening to p is prevented as follows: it is likely that at least one of the weights coming into a C neuron is negative, in which case, increasing the difference would involve making the negative weight more negative, resulting in the neuron joining either A or B (as it no longer fires for the pattern showing the negative weight), thus reducing p.

When the neurons in C remain, more complicated case arising: here, a decreases, but p may also decrease correspondingly; another undesirable scenario is when b decreases to become less than q. Typically sleep tends to drive the values of weights of opposite signs and weights of same sign by differ by some threshold value, away from each other (as mentioned earlier) but there are conditions when the difference between weights is below a threshold point for sleep to cause divergence. In cases where differences are above threshold sleep improved performance and sleep did improve performance when differences are lower.

### 3) Sleep Recovers Tasks Lost Due to Catastrophic Forgetting in MNIST and CUB200

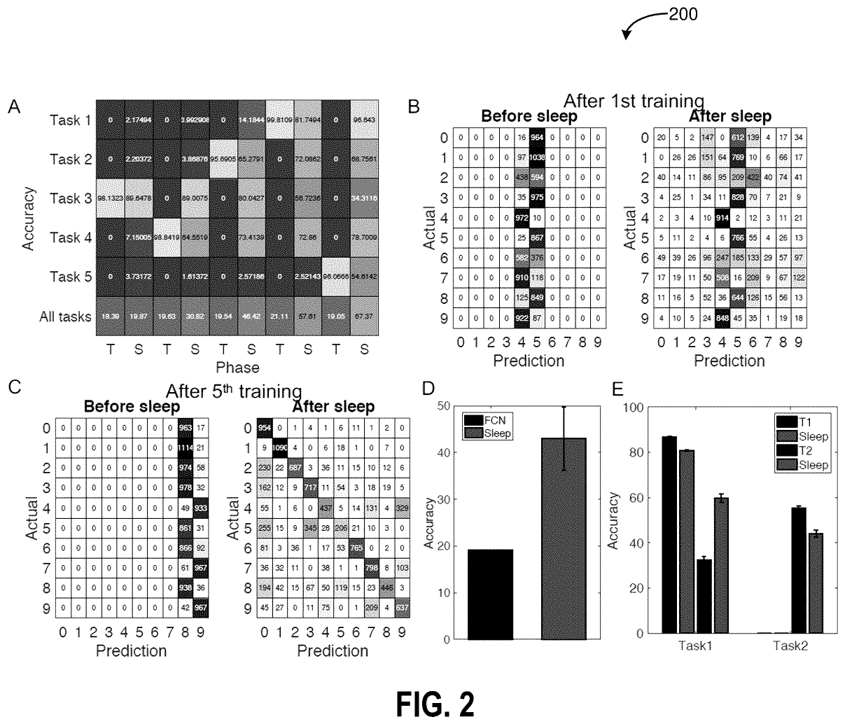

ANNs have been shown to suffer from catastrophic forgetting whereby they perform well on the recently learned tasks but fail at previously learned tasks for various datasets including MNIST and CUB200. FIG. 2 provides an example implementation 200 of the presently disclosed technology applying MNIST and CUB200 datasets. Referring to FIG. 2, an example process was conducted as follows: 5 tasks for the MNIST dataset and 2 tasks for the CUB200 dataset were created. Each pair of digits in MNIST were defined as a single task, and half of the classes in CUB200 were considered a single task. Each task was incrementally trained, followed by a sleep phase, until all tasks were trained. A baseline network trained incrementally without sleep performed poorly (FIG. 2D, black bar). However, it is noted a significant improvement in the overall performance, as well as task specific performance when sleep algorithm was incorporated into the training cycle (FIG. 2D, red bar).

For MNIST, the results indicated each of the five tasks revealed an increase in classification accuracy after sleep even after being completely forgotten during awake training (FIG. 2A). For the 1st training+sleep cycle, the “before sleep” network only classifies images for the task that was seen during last training (digits 4-5 on the x-axis in FIG. 2B). After sleep, performance remains high on digits 4 and 5 but there is also spillover into the other digits. For the last training+sleep cycle, same effect was observed. Only last task performed well right after the training (FIG. 2C). After sleep, performance on almost all digits nearly recovered (FIG. 2D). On the CUB200 dataset, the results indicated that sleep can recover task 1 performance after training on task 2, with only minimal loss to task 2 performance (FIG. 2E). In conclusion, the sleep algorithm reduces catastrophic forgetting by reducing overlap between network activity for distinct classes.

Although specific performance numbers here are not as impressive as for generative models, they surpass certain regularization methods, such as EWC, on incremental learning.

Overall, several embodiments of the sleep algorithm can reduce catastrophic forgetting and interference with very little knowledge of the previously learned examples solely by utilizing STDP to reactivate forgotten weights. Ultimately, these results suggest that information about old tasks is not completely lost when catastrophic forgetting occurs from performance level perspective but the information remains present in the weights about old tasks and offline STDP phase can resurrect this hidden information. To achieve higher performance, offline STDP/sleep algorithm could be combined with generative replay to replay specific, rather than average, inputs during sleep.

### 4) Sleep Promotes Separation of Internal Representations for Different Inputs

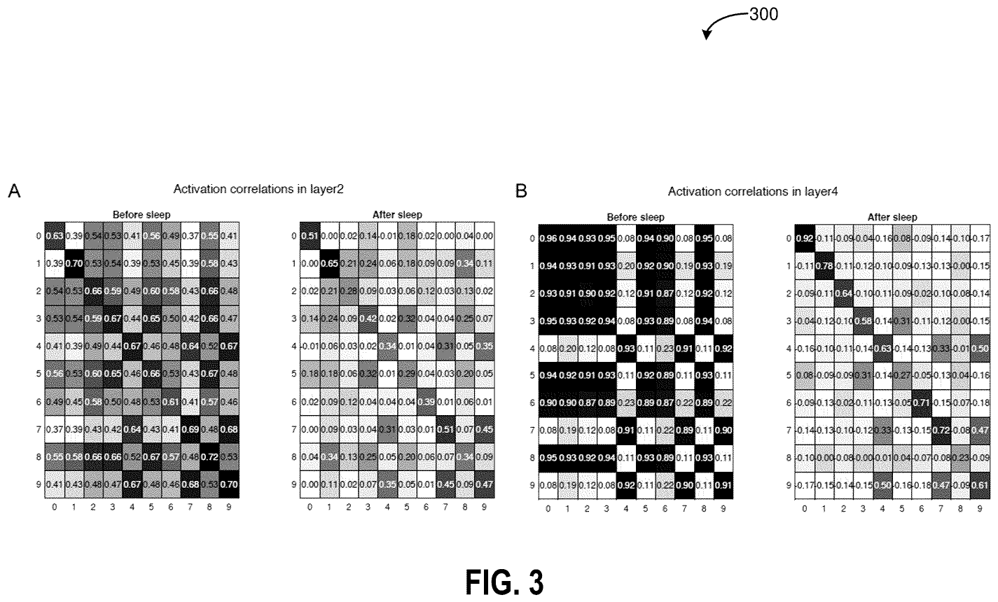

As suggested by example embodiments above, sleep could separate the neurons belonging to the different input categories and prevent catastrophic forgetting. This would also result in a change in the internal representation of the different inputs in the network. The suggestion or finding was explored by analyzing the network trained on MNIST before and after sleep. In order to examine how the internal representation of the different tasks are related and modified after sleep, the correlation between ANN activation at different layers after awake training and after sleep was examined. Namely, FIG. 3 illustrates example correlation graphs 300 of the presently disclosed technology demonstrating sleep decreases representational overlap between MNIST classes at all layers. Referring to FIG. 3, the average correlation was computed between activations of examples of class i with examples of class j. As seen in FIG. 3, the correlation before sleep was higher both within the same input category and across all categories (Graphs immediately adjacent reference identifiers 3A and 3B, respectively). On the other hand, after sleep, the correlations between different categories were reduced while the correlation within category remained high (Graphs not immediately adjacent reference identifiers 3A and 3B, respectively). As such, these correlation graphs suggest that sleep promotes decorrelating the internal representations of the input categories, illustrating a mechanism by which sleep can prevent catastrophic forgetting.

### 5) Sleep Improves Generalization

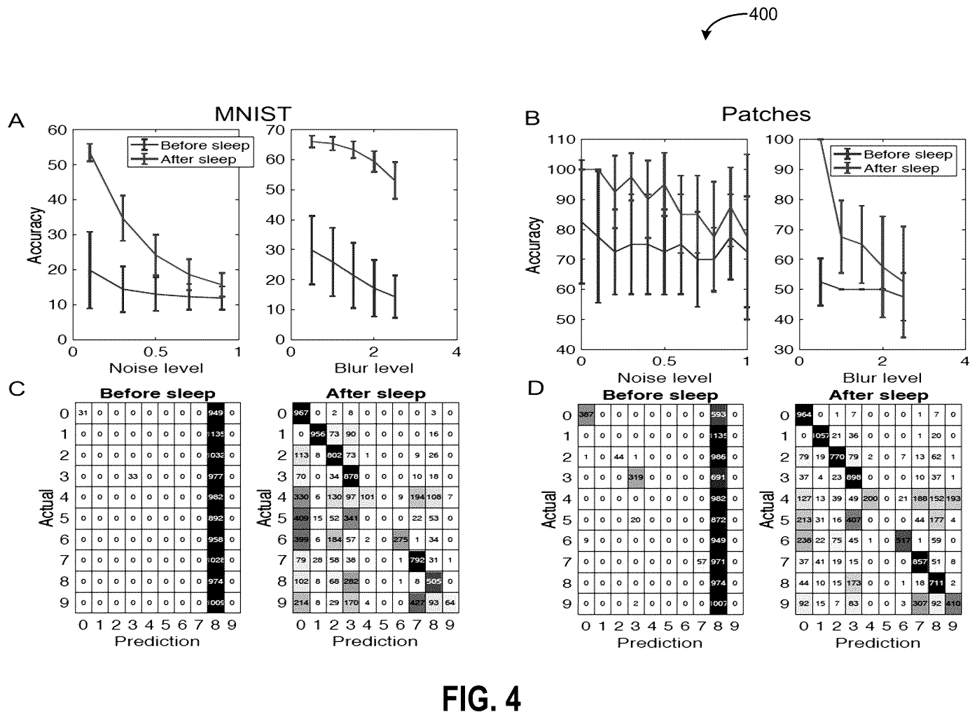

An additional advantage provided by the presently disclosed technology is elucidated by the tested effect of sleep on the common problem of generalization in machine learning. That is, previous research has reported a failure of neural networks to generalize beyond their explicit training set. Given that sleep may create a more generalized representation of stimulus parameters, the hypothesis that the sleep algorithm would increase ANN's ability to generalize beyond the training set was tested. To do so, noisy and blurred versions of the MNIST and Patches examples were created and tested the network before and after sleep on these distorted datasets. FIG. 4 illustrates the results 400 and establishes sleep can substantially increase the network's ability to classify degraded images. For both the MNIST and Patches dataset, the “after sleep” network substantially outperformed the “before sleep” network on classifying noisy and blurred images. This is shown in the confusion matrices in FIGS. 4C and 4D, where before sleep, the network trained on intact MNIST images favors one class over another when tested on degraded images. However, sleep restores the activity so that other classes are correctly predicted. It is important to note the MNIST network is trained sub-optimally to show a case where the network performs low on degraded images. The same network architecture can perform well without sleep on degraded images if the training dataset is significantly expanded.

These results highlight the benefit of utilizing sleep to generalize representation of the task at hand. ANNs are normally trained on highly filtered datasets that are identically and independently distributed. However, in a real-world scenario, inputs may not meet these assumptions. Incorporating a sleep-phase into training of ANNs may enable a more generalized representation of the input statistics, such that distributions which are not explicitly trained may still be represented by the network after sleep.

### 6) Sleep Improves Resistance to Adversarial Attacks

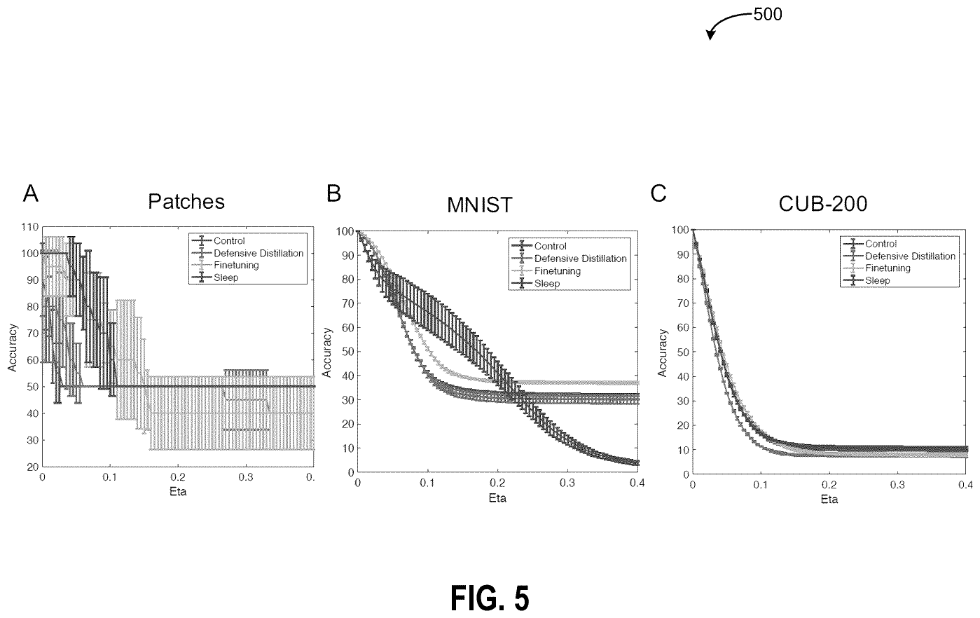

Another advantage provided by the presently disclosed technology is evidenced by the verified effect that sleep can have on the resistance to adversarial attacks of neural networks (network). Currently, networks are prone to adversarial attacks, whereby an attacker creates an example input that a network misclassifies. Usually adding an imperceptible amount of noise to an image (i.e., input) can change how a network classifies the image. This could lead to catastrophic effects when a network are utilized in real-world scenarios. The presently disclosed technology may reduce the impact of adversarial attacks in the same way that it increases the generalization ability of networks which enables machine learning architectures to be resistant to various types of noise, as supported in the datasets illustrated in FIG. 5. Specifically, FIG. 5 provides an example implementation and evaluation of the sleep algorithm in Patches, MNIST, and CUB200 datasets during adversarial attacks. As suggested above, the sleep algorithm of the presently disclosed technology can reduce the impact of one or more adversarial attacks in the Patches dataset (FIG. 5A), the MNIST dataset (FIG. 5B), and the CUB200 dataset (FIG. 5C). Each graph provides a classification accuracy (x-axis) as a function of noise added, Eta (y-axis), for respective datasets. As shown, the sleep algorithm of the present disclosure overperformed a control algorithm in various datasets as well as various forms of adversarial attacks. As such, embodiments of the presently disclosed technology can simultaneously improve generalization of training data and resistance to adversarial attacks of networks.

### C. Sleep Algorithm Hardware

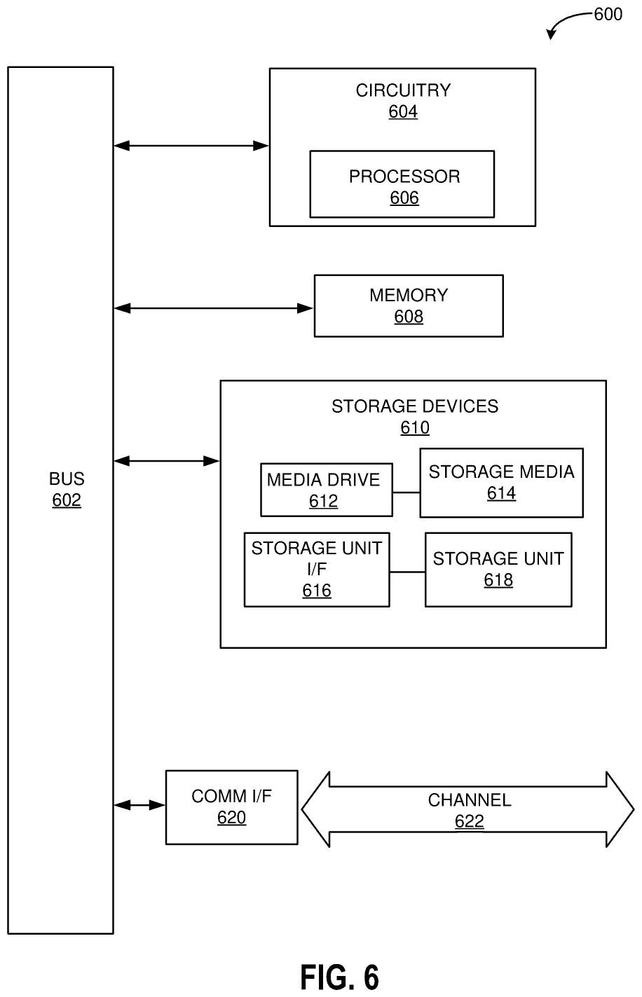

FIG. 6 illustrates example computing component 600, which may in some instances include a processor on a computer system (e.g., control circuit). Computing component 600 may be used to implement various features and/or functionality of embodiments of the systems, devices, and methods disclosed herein. With regard to the above-described embodiments set forth herein in the context of systems, devices, and methods described with reference to FIGS. 1-6, including embodiments involving the control circuit, one of skill in the art will appreciate additional variations and details regarding the functionality of these embodiments that may be carried out by computing component 600. In this connection, it will also be appreciated by one of skill in the art upon studying the present disclosure that features and aspects of the various embodiments (e.g., systems) described herein may be implemented with respected to other embodiments (e.g., methods) described herein without departing from the spirit of the disclosure.

As used herein, the term component may describe a given unit of functionality that may be performed in accordance with one or more embodiments of the present disclosure. As used herein, a component may be implemented utilizing any form of hardware, software, or a combination thereof. For example, one or more processors, controllers, ASICs, PLAs, PALs, CPLDs, FPGAs, logical components, software routines, or other mechanisms may be implemented to make up a component. In implementation, the various components described herein may be implemented as discrete components or the functions and features described may be shared in part or in total among one or more components. In other words, as would be apparent to one of ordinary skill in the art after reading this description, the various features and functionality described herein may be implemented in any given application and may be implemented in one or more separate or shared components in various combinations and permutations. Even though various features or elements of functionality may be individually described or claimed as separate components, one of ordinary skill in the art will understand upon studying the present disclosure that these features and functionality may be shared among one or more common software and hardware elements, and such description shall not require or imply that separate hardware or software components are used to implement such features or functionality.

Where components or components of the disclosure are implemented in whole or in part using software, in embodiments, these software elements may be implemented to operate with a computing or processing component capable of carrying out the functionality described with respect thereto. One such example computing component is shown in FIG. 5. Various embodiments are described in terms of example computing component 500. After reading this description, it will become apparent to a person skilled in the relevant art how to implement example configurations described herein using other computing components or architectures.

Referring now to FIG. 6, computing component 600 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing component 600 is specifically purposed.

Computing component 600 may include, for example, one or more processors, controllers, control components, or other processing devices, such as a processor 606, and such as may be included in circuitry 604. Processor 606 may be implemented using a special-purpose processing engine such as, for example, a microprocessor, controller, or other control logic. In the illustrated example, processor 606 is connected to bus 602 by way of circuitry 604, although any communication medium may be used to facilitate interaction with other components of computing component 600 or to communicate externally.

Computing component 600 may also include one or more memory components, simply referred to herein as main memory 608. For example, random access memory (RAM) or other dynamic memory may be used for storing information and instructions to be executed by processor 606 or circuitry 604. Main memory 608 may also be used for storing temporary variables or other intermediate information during execution of instructions to be executed by processor 606 or circuitry 604. Computing component 600 may likewise include a read only memory (ROM) or other static storage device coupled to bus 602 for storing static information and instructions for processor 606 or circuitry 604.

Computing component 600 may also include one or more various forms of information storage devices 610, which may include, for example, media drive 612 and storage unit interface 616. Media drive 612 may include a drive or other mechanism to support fixed or removable storage media 614. For example, a hard disk drive, a floppy disk drive, a magnetic tape drive, an optical disk drive, a CD or DVD drive (R or RW), or other removable or fixed media drive may be provided. Accordingly, removable storage media 614 may include, for example, a hard disk, a floppy disk, magnetic tape, cartridge, optical disk, a CD or DVD, or other fixed or removable medium that is read by, written to or accessed by media drive 612. As these examples illustrate, removable storage media 614 may include a computer usable storage medium having stored therein computer software or data.

In alternative embodiments, information storage devices 610 may include other similar instrumentalities for allowing computer programs or other instructions or data to be loaded into computing component 600. Such instrumentalities may include, for example, fixed or removable storage unit 618 and storage unit interface 616. Examples of such removable storage units 618 and storage unit interfaces 616 may include a program cartridge and cartridge interface, a removable memory (for example, a flash memory or other removable memory component) and memory slot, a PCMCIA slot and card, and other fixed or removable storage units 618 and storage unit interfaces 616 that allow software and data to be transferred from removable storage unit 618 to computing component 600.

Computing component 600 may also include a communications interface 620. Communications interface 620 may be used to allow software and data to be transferred between computing component 600 and external devices. Examples of communications interface 620 include a modem or softmodem, a network interface (such as an Ethernet, network interface card, WiMedia, IEEE 1212.XX, or other interface), a communications port (such as for example, a USB port, IR port, RS232 port Bluetooth® interface, or other port), or other communications interface. Software and data transferred via communications interface 620 may typically be carried on signals, which may be electronic, electromagnetic (which includes optical) or other signals capable of being exchanged by a given communications interface 620. These signals may be provided to/from communications interface 620 via channel 622. Channel 622 may carry signals and may be implemented using a wired or wireless communication medium. Some non-limiting examples of channel 622 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 608, storage unit interface 616, removable storage media 614, and channel 622. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing component 600 or a processor 606 to perform features or functions of the present disclosure as discussed herein.

### Convolutional Neural Networks

As alluded to above, computer science has made remarkable advancements in the development of neural network models capable of performing intricate visual tasks. Deep learning, in particular, has played a pivotal role in driving this progress, with convolutional neural networks (CNNs) emerging as a significant breakthrough. Inspired by the structural characteristics of the human visual system, CNNs owe their success in large part to the introduction of convolutional layers. By combining convolutional and feedforward layers, deep networks have achieved state-of-the-art performance for classification and generative tasks.

However, despite their proven usefulness, convolutional filters have certain limitations. While the human visual system excels at accurately performing image-based tasks, even in the presence of substantial perturbations, CNNs trained using backpropagation-based methods can be highly sensitive to distortions. The impressive performance of these networks can quickly degrade when models operate in real-life applications and dynamic uncontrolled environments modify inputs with perturbations such as additive noise, blur, or other distortions (e.g., lighting, image quality, background, contrast, and perspective). This decrease in performance can be attributed to the perturbations degrading the quality of features that the convolutional layers are able to extract. Since the convolutional layers are trained on unperturbed (clean) images, they may be unable to extract useful features from distorted ones. Many existing methods for improving the robustness of convolutional filters involve explicit finetuning on predefined sets of perturbations or data augmentations. However, such supervised approaches generally require prior knowledge of the specific deformations or extensive training, meaning that these techniques can face challenges when limited data is available for fine-tuning or when unforeseen and untrained distortions are encountered in real-world scenarios. As a result, this can lead to a lack of generalization to out-of-distribution examples.

In contrast, biological systems have leveraged other mechanisms to improve memory representation and increase generalizability. Sleep has long been known to enhance learning in situations with limited experience, facilitate continuous learning, generalize knowledge acquired during wakefulness, and enable backward and forward transfer of knowledge. This functionality is prevalent and highly stereotyped in a variety of species ranging from insects to mammals. Two crucial components are believed to underlie the role of sleep in memory consolidation: (1) the spontaneous replay of memory traces in the absence of external input; and (2) local unsupervised synaptic plasticity that modifies synaptic weights. As embodiments of the presently disclosed technology are designed in appreciation of, applying sleep-like processing, such as Sleep Replay Consolidation (SRC), to fully connected feedforward networks can enhance continual learning during sequential task training and improve model robustness and generalizability.

While other biologically inspired approaches to enhance network generalizability to visual distortions exist, they often suffer from increased computational cost, lack dynamism, or require gathering expensive neural recordings or other hard to acquire data.

To address these limitations, systems and methods of the presently disclosed technology provide a novel approach that implements SRC in convolutional layers to provide a dynamic solution with low/reduced inference computation costs.

The presently disclosed SRC methodology can be implemented by transforming a neural network from a CNN to a spiking neural network (SNN) and simulating unsupervised replay in the transformed neural network (i.e., when the neural network is transformed into the SNN). This may involve: (a) replacing an original ReLU activation function of the CNN with a Heaviside function to gain a notion of spikes; (b) introducing input noise reflective of training data to induce network activity; and (c) applying local Hebbian-type plasticity rules to convolutional layers to modify synapses based on spiking patterns.

Advantages to the presently disclosed approach include improving robustness and generalization to noisy outputs, low/reduced computational costs (e.g., inference costs), and in some implementations, no need for prior knowledge of the type of input perturbation. By contrast, alternative biologically motivated methodologies can be more costly and fine-tuning such methodologies only improves performance on pre-defined augmentations.

### A. Data and Distortions

In accordance with example experiments, examples of the presently disclosed SRC models were evaluated using two well-known image classification data sets, MNIST and CIFAR-10, and further by incorporating standard distortions commonly encountered in both machine learning and real-world environments. These distortions included Gaussian blur, Additive Gaussian noise, Salt & pepper, and Speckle, with varying intensities.

MNIST consists of 60,000 28×28 monochromatic handwritten digits (0-9) while CIFAR-10 contains 60,000 32×32 color images of 10 classes (cars, birds, ships, etc.). Distortions were applied to the MNIST and CIFAR-10 data sets to test how different models, including examples of the presently disclosed SRC models, performed across the different distortions and varying intensities of the distortions.

As alluded to above, distortions applied to the data sets included Gaussian blur (GB), Additive Gaussian noise (GN), Salt and pepper (SP), and Speckle (SE).

Gaussian blur (GB) may involve convolving an input image with a Gaussian kernel with varying o values used to modify intensity. This type of distortion can be introduced when items present in the input image are in motion.

Additive Gaussian noise (GN) may refer to when noise drawn from a Gaussian distribution is added pixel-wise to the input image.

Salt and pepper (SP), also known as impulse noise, randomly selects input image pixels and sets them to either the minimum or maximum possible input value. The frequency of pixels may be selected to control intensity. This type of input noise can arise in digital images taken by cameras with faulty sensors.

Speckle (SE) may refer to a pixel-wise multiplicative noise where a random value is drawn from a Gaussian distribution and multiplied with an original pixel value to generate the new input values. Speckle noise is commonly a result of wave interference in images that are generated through the emission of specific frequencies of light, such as ultrasound and/or radar.

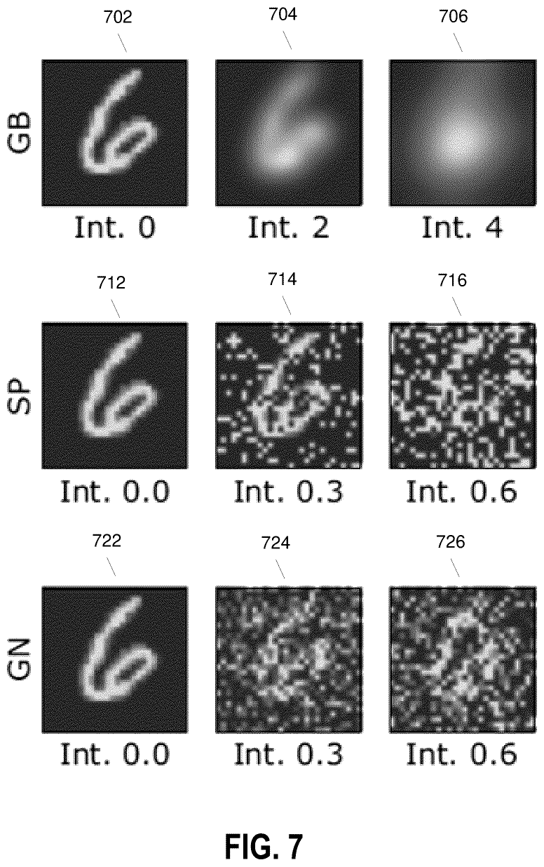

FIG. 7 shows visualizations via example images from MINST with various distortion types and intensity (Int.). Image 702 is a handwritten “six” with GB distortion applied at an intensity of 0. Image 704 shows the same handwritten “six” with GB distortion applied at an intensity of 2. Image 706 shows the same handwritten “six” with GB distortion applied at an intensity of 6.

Image 712 is a handwritten “six” with SP distortion applied at an intensity of 0.0. Image 714 shows the same handwritten “six” with SP distortion applied at an intensity of 0.3. Image 716 shows the same handwritten “six” with SP distortion applied at an intensity of 0.6.

Image 722 is a handwritten “six” with GN distortion applied at an intensity of 0.0. Image 724 shows the same handwritten “six” with GN distortion applied at an intensity of 0.3. Image 726 shows the same handwritten “six” with GN distortion applied at an intensity of 0.6.

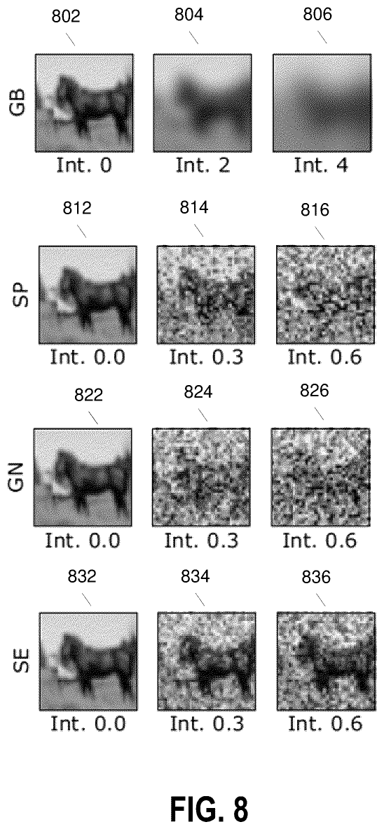

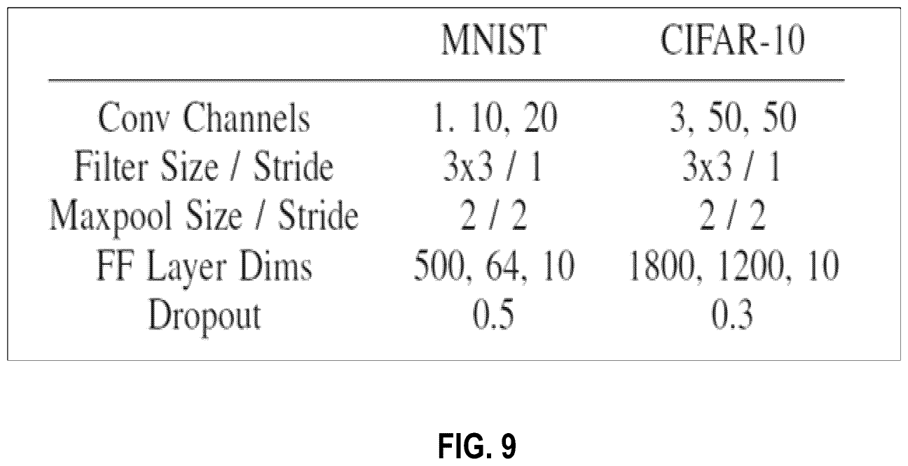

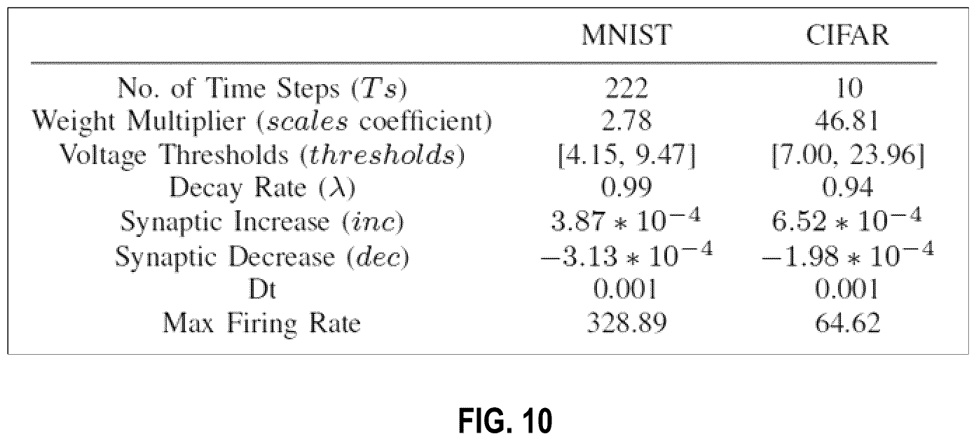

FIG. 8 shows visualizations via example images from CIFAR-10 with various distortions types and intensity (Int.). Image 802 is an image of horses in a field with GB distortion applied at an intensity of 0. Image 804 shows the image of horses in a field with GB distortion applied at an intensity of 2. Image 806 shows the same image of horses in a field with GB distortion applied at an intensity of 4.

Image 812 is an image of horses in a field with SP distortion applied at an intensity of 0.0. Image 814 shows the same image of horses in a field with SP distortion applied at an intensity of 0.3. Image 816 shows the same image of horses in a field with SP distortion applied at an intensity of 0.6.

Image 822 is an image of horses in a field with GN distortion applied at an intensity of 0.0. Image 824 shows the same image of horses in a field with SP distortion applied at an intensity of 0.3. Image 826 shows the same image of horses in a field with SP distortion applied at an intensity of 0.6.

Image 832 is an image of horses in a field with SP distortion applied at an intensity of 0.0. Image 834 shows the same image of horses in a field with SP distortion applied at an intensity of 0.3. Image 836 shows the same image of horses in a field with SP distortion applied at an intensity of 0.6.

As depicted in FIG. 7 and FIG. 8, the application of distortion to images at increased intensity makes recognition of the images more difficult, not only for humans but also for neural network models. Some distortions make image recognition more difficult than others. For example, distortions such as brightening/darkening may yield miniscule degradation in performance. As a result, for any image recognition training of neural networks, distortions that cause significant decline in accuracy for the baseline model are often selected. For image recognition training of neural networks distortion values may be clamped to keep the inputs for the model in a reasonable range.

### B. Models

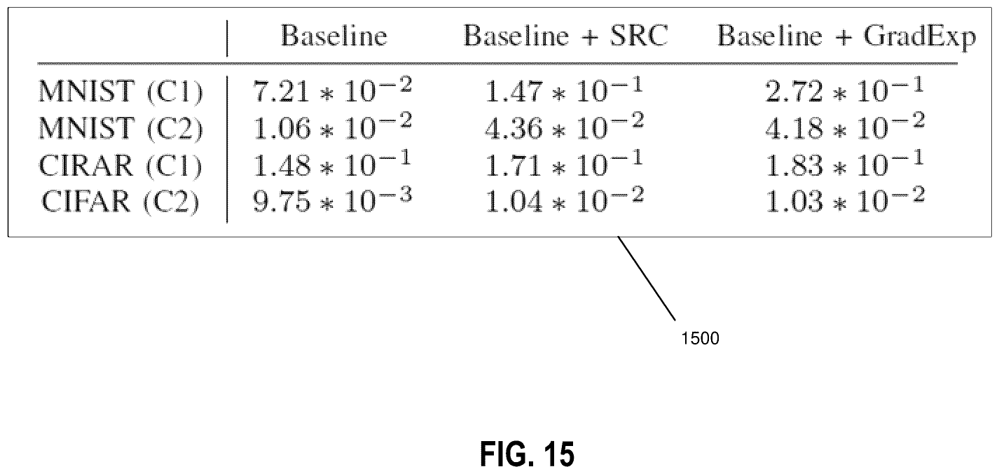

In an effort to generate interpretable results, the example experiments utilized smaller, more simple models with the goal of improving transparency and understandability of the underlying mechanisms. For MNIST, a four-layer CNN consisting of two convolutional and two feedforward layers was used. Both convolutional layers leveraged 3×3 filters with a stride of one, no padding, and a ReLU activation. Each filter bank had 1/10 input channels and 10/20 output channels respectively. After each convolution there was a maxpool with a window size and stride of two. The feedforward layers received an input that matched the output size of the convolutional layers (500) followed by a hidden layer of size 64 with an output size of 10. The hidden layer leveraged a ReLU activation function and dropout during training with a rate of 0.5. The CIFAR model was of a similar structure with the only differences being the number of channels in the convolutional layers which was increased to 3/50 and 50/50 and the size of the feedforward portion of the network receiving a 1800 dimensional vector as an input with a 1200 dimensional hidden layer, the output was kept to 10 units. All layers present, both feedforward and convolutional, omitted bias terms to allow for a standard conversion to a spiking neural network, this did not notably impact the overall performance of these networks. Model parameters are for the CNNs are depicted in table 1500 of FIG. 15.

### C. Sleep Replay Consolidation (SRC)

An SRC process of the presently disclosed technology may first involve transforming a neural network from a CNN to an SNN. When the neural network is transformed into the SNN, the SRC process may involve modifying synaptic weights of the neural network by applying a simulated memory replay process to the neural network, during which unsupervised synaptic modifications may occur. After applying the simulated memory replay process to the neural network, the SRC process may involve transforming the neural network from the synaptic weight-modified SNN to a synaptic weight-modified CNN. The synaptic weight-modified CNN may then be used in a CNN forward pass.

In certain embodiments, original network structure may be preserved when transforming the neural network from the CNN to the SNN. A membrane potential (e.g., a voltage) may be simulated for each node/neuron in the neural network. A respective voltage/membrane potential may be comprised of a running sum of inputs determined by presynaptic activity combined with the input weights and may be subject to decay, effectively simulating dynamics of a leaky integrate and fire neuron. A ReLU activation may be swapped for a Heaviside function to develop a notion of spikes. Once a neuron's membrane potential surpasses the given threshold, the neuron may emit a spike and the voltage can be reset to 0. To ensure that activity propagates across layers, layer wise scale factors to synaptic weights may be generated in accordance with different data-based normalization techniques and may be further multiplied by a hyperparameter coefficient. These modifications can be applied to convolutional layer neurons, successfully converting CNN to SNN, while preserving network architecture and synaptic weight structure.

During the sleep phase, the SNN's activity may be driven by a randomly distributed Poisson spiking input with firing rates determined by the average values of each input pixel activation from a training data set. Hebbian style learning rules can be applied to modify the weights. For example, a weight may be increased between two nodes when both pre- and post-synaptic nodes are activated and a weight may be decreased when the post-synaptic node is activated but the pre-synaptic node is not. After this unsupervised sleep period has been executed, the CNN model can be restored by eliminating the simulated voltage, removing scale factors, and restoring the original activation functions.

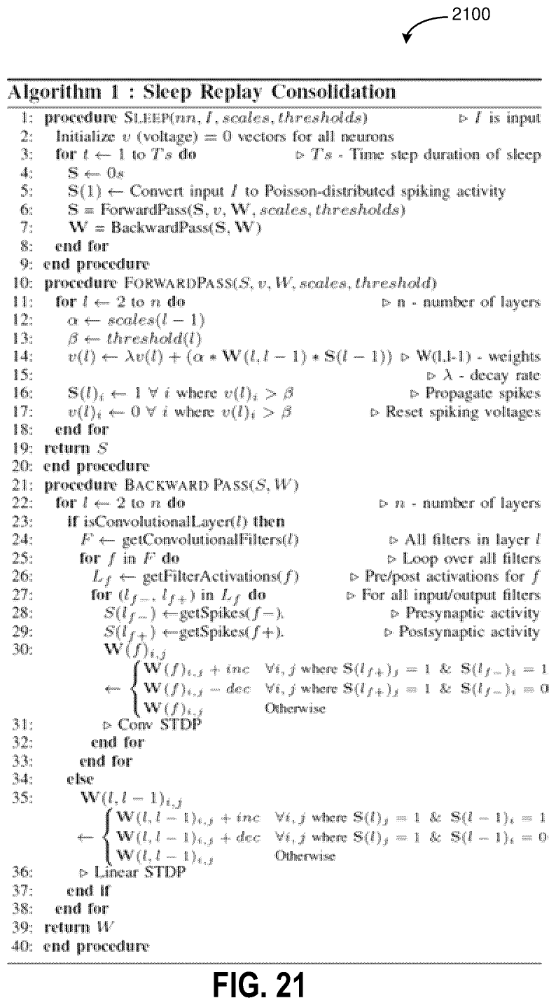

An example pseudo-code algorithm 2100 for the above-described SRC process is depicted in FIG. 21.

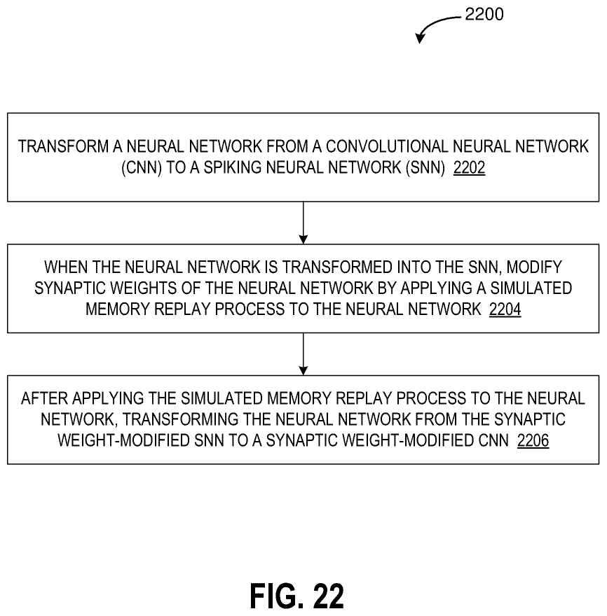

FIG. 22 illustrates an example method 2200 in accordance with the presently disclosed SRC process described above.

As depicted, operation 2202 may involve transforming a neural network from a convolutional neural network (CNN) to a spiking neural network (SNN). In some of such implementations, transforming the neural network from the CNN to the SNN may comprise preserving the (same) network architecture (e.g., neuron and synaptic weight architecture) for the neural network.

In various implementations (and as described above), transforming the neural network from the CNN to the SNN may comprise: (a) simulating a membrane potential for each neuron of the neural network; (b) replacing an original activation function of the neural network with a Heaviside function to facilitate spikes such that when the simulated membrane potential of a respective neuron surpasses a pre-determined threshold, the respective neuron emits a spike; and (c) applying layer-wise scale factors to the synaptic weights of the neural network to facility activity across all layers of the neural network.

In certain implementations (and as described above), the simulated membrane potential for the respective neuron may comprise a voltage reflecting a running sum of inputs determined by synaptic activity preceding the respective neuron in the neural network combined with synaptic weights preceding the respective neuron in the neural network. Here (and as described above), the simulated membrane potential for the respective neuron may be subject to decay to simulate dynamics of a leaky integrate and neuron fire. In some implementations, simulating the membrane potential for each neuron of the neural network may comprise resetting the membrane potential for the respective neuron to a zero value when the respective neuron emits a spike.

In various implementations (and as described above), applying the layer-wise scale factors to the synaptic weights of the neural may comprise generating a respective layer-wise scale factor in accordance with a data-based normalization technique and multiplication with a hyperparameter coefficient.

In some implementations (and as described above), the (replaced) original activation function of the neural network may comprise a ReLU activation function.

As depicted in FIG. 22, when the neural network is transformed into the SNN, operation 2204 may involve modifying synaptic weights of the neural network by applying a simulated memory replay process to the neural network.

In some implementations (and as described above), modifying the synaptic weights of the neural network by applying the simulated memory replay process to the neural network may comprise applying a randomly distributed spiking input to the neural network and applying Hebbian-based learning rules to modify the synaptic weights. In certain of these implementations, the randomly distributed spiking input may comprise a randomly distributed Poisson spiking input with firing rates determined by average values of each input pixel of a training dataset. Relatedly, the Hebbian-based learning rules may comprise: (i) increasing a respective synaptic weight connecting a first neuron to a second neuron when both the first and second neuron are activated, wherein the first neuron is a pre-synaptic connection neuron and the second neuron is a post-synaptic connection neuron; and (ii) decreasing the respective synaptic weight when the second neuron is activated and the first neuron is not activated.

As depicted in FIG. 22, after applying the simulated memory replay process to the neural network, operation 2206 may involve transforming the neural network from the synaptic weight-modified SNN to a synaptic weight-modified CNN.

In various implementations, transforming the neural network from the synaptic weight-modified SNN to the synaptic weight-modified CNN may comprise: (a) removing the simulated membrane potentials from the neural network; (b) removing the layer-wise scale factors from the neural network; and (c) replacing the Heavyside function with the original activation function for the neural network.

In various implementations, the above-described approach can be directly applied to a fully connected network since it produces one-to-one mapping from any pair of pre and post activations to the corresponding synaptic weights. However, implementing this to convolutional layers can be more complicated. Because of parameter sharing, a single synaptic weight may take part in multiple synaptic events. Thus, based on the network activity, the same set of synaptic weights may need to be updated multiple times during a single iteration of SRC, thus accumulating synaptic updates over all activations that are associated to a given convolutional weight for every iteration. The SRC hyperparameters may be selected through the use of a standard python Genetic Algorithm implementation tasked to optimize mean validation performance over different types of distortions.

### D. Experimental Design

In testing neural networks, it is important that all models tested undergo standard training protocol to ensure accuracy and reliability of results. For example, in accordance with example embodiments, native MNIST and CIFAR-10 models may be trained for 50 epochs with a learning rate of 0.01/0.3 on the undistorted data set until a steady performance is achieved. Additionally, a binary cross entropy loss function along with a standard stochastic gradient decent optimizer may be utilized to alter model parameters. Following baseline training models may undergo periods of SRC and subsequent Feedforward Fitting.

Testing according to example embodiments may be repeated a number of times, e.g. 10 trials, with each of the trials receiving a unique random seed, which results in differences in model weight initialization, training sample order, and SRC input noise generation.

### E. Results

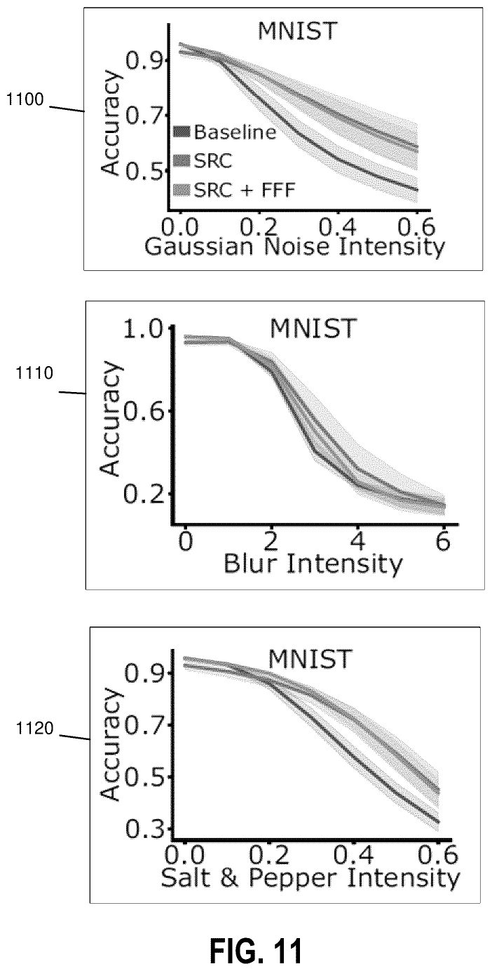

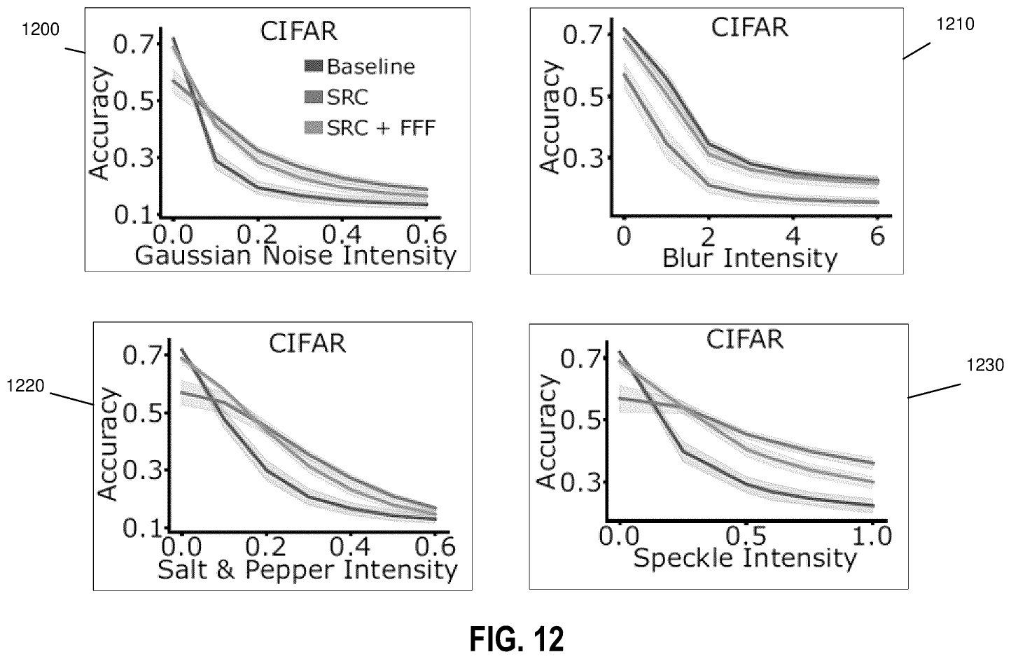

FIG. 11 and FIG. 12 show test results from a ten trial test using a baseline CNN model comprised of two convolutional and two feedforward layers according to example embodiments. To establish a baseline model, a model was trained on clean unperturbed images until a plateaued mean performance of roughly 95% for MNIST and 70% for CIFAR-10 accuracy on an undistorted data set was achieved. After achieving a sufficient baseline model, the baseline model can be tested across a variety of distortions.

According to one embodiment, after establishing the baseline, SRC may be applied to exclusively to the conventional layers, and performance is tested above using another ten trial test. This type of testing can be applied to both MNIST and CIFAR-10, additionally, different distortions can also be applied to test the performance of SRC.

According to another embodiment, another training stage can be implemented that such that the training involves SRC and Feedforward Fitting (“FFF”). This type of testing may include the feedforward head of the network undergoing minimal training on the undistorted training data set with labels or features, or both, being extracted by frozen convolutional weights that are used to perform backpropagation on the feedforward layers only. As a result, the process can be adjust the decision making head of the network to the newly developed feature extractors formed after SRC. FFF may be applied until training set performance is saturated.

FIG. 11 shows the results of image recognition for MNIST, with different distortions applied, of ten trial tests for each of a baseline model, a SRC model, and a SRC+FFF model according to example embodiments. The results show the accuracy of each respective model as the intensity of a particular blur is increased, the lines of the graphs represent the mean across the trials while the shaded regions surrounding each line represents the standard deviation across the trials. Graph 1100 shows the results for ten trial test of each of a baseline model, and SRC model, and a SRC+FFF model for MNIST with Gaussian Noise distortion applied. Graph 1110 shows the results for ten trial test of each of a baseline model, and SRC model, and a SRC+FFF model for MNIST with Blur distortion applied. Graph 1120 shows the results for ten trial test of each of a baseline model, and SRC model, and a SRC+FFF model for MNIST with a Salt and Pepper distortion applied.

FIG. 12 shows the results of image recognition for CIFAR-10, with different distortions applied, of ten trial tests for each of a baseline model, a SRC model, and a SRC+FFF model according to example embodiments. The results show the accuracy of each respective model as the intensity of a particular blur is increased, the lines of the graphs represent the mean across the trials while the shaded regions surrounding each line represents the standard deviation across the trials. Graph 1200 shows the results for ten trial test of each of a baseline model, and SRC model, and a SRC+FFF model for CIFAR-10 with Gaussian Noise distortion applied. Graph 1210 shows the results for ten trial test of each of a baseline model, and SRC model, and a SRC+FFF model for CIFAR-10 with Blur distortion applied. Graph 1220 shows the results for ten trial test of each of a baseline model, and SRC model, and a SRC+FFF model for CIFAR-10 with a Salt and Pepper distortion applied. Graph 1230 shows the results for ten trial test of each of a baseline model, and SRC model, and a SRC+FFF model for CIFAR-10 with a Speckle distortion applied.

The test results shown in FIG. 11 and FIG. 12 show that the SRC and SRC+FFF outperform the baseline model in the tests for all but one of the types of distortions applied. More specifically, for larger distortion intensity values, the SRC model improved performance up to about 15% for MNIST and 10% for CIFAR-10. The test results also show improvement in performance on heavily distorted inputs following SRC. Additionally, the SRC+FFF model regained some of the lost performance on the minimally distorted data sets while significantly maintaining the performance gained for higher distortions.

A classic machine learning approach to gain model performance on new data distributions is fine-tuning (“FT”). Fine tuning, while being an effective paradigm requires foresight of specific potential data perturbations and additional time to train the model, nonetheless it remains a leading benchmark for accuracy of neural network models. Accordingly neural network models are often compared to the standard supervised method of fine tuning.

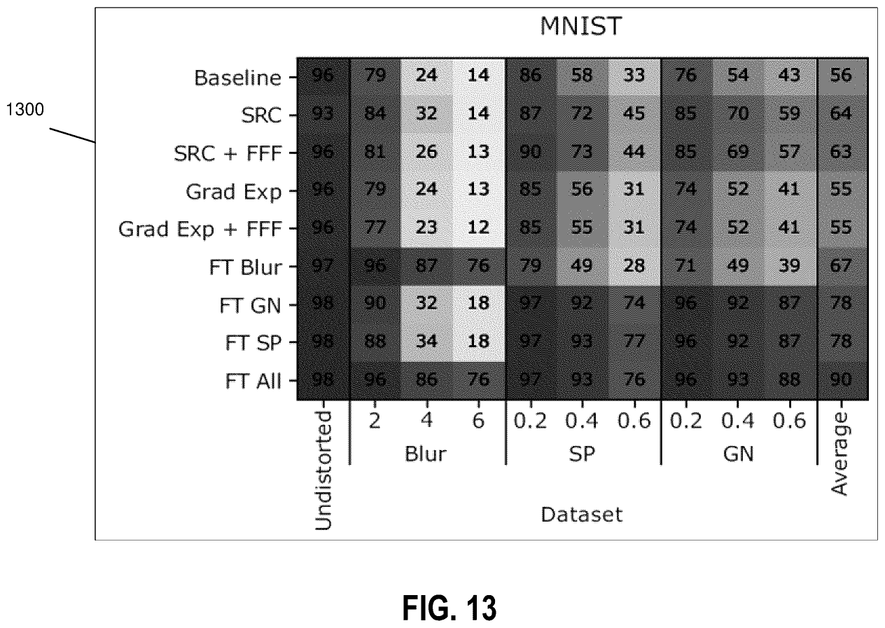

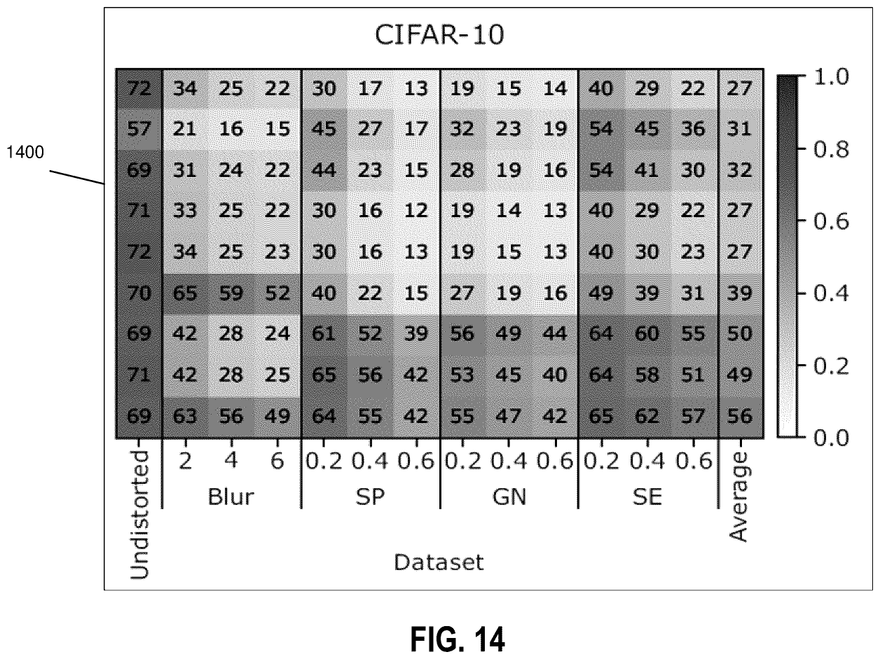

FIG. 13 and FIG. 14 show the model performance for various models, including a baseline model, standard fine tuning models, and models according to embodiments such as SRC and SRC+FFF. In comparing the different models, fine-tuned models specialized in each specific distortion were developed. Specifically, the fine-tuned models were initialized using weights from the model trained on undistorted data, and subsequently underwent 10 additional epochs of training (with learning rates of 0.05/0.15 for MNIST/CIFAR-10) using the specialized data set comprised of the undistorted data combined with varying levels of distortion from their expertise. To compare model performance of the different models, the average accuracy of each model across ten trials was collected.

Graph 1300 shows the results of the model performance for MNIST of a baseline model, an SRC model, a SRC+FFF model, a Gradient Expansion model, a Gradient Expansion+FFF model, a FT Blur model, a FT GN model, a FT SP model, and a FT All model. Each model underwent a ten trial test for each of an undistorted MNIST dataset, the MNIST dataset with a blur distortion applied at three different intensities, the MNIST dataset with a SP distortion applied at three different intensities, and the MNIST dataset with a GN distortion applied at three different intensities. Graph 1300 also shows the average accuracy of all of the tests for each model.

Graph 1400 shows the results of the model performance for CIFAR-10 of a baseline model, an SRC model, a SRC+FFF model, a Gradient Expansion model, a Gradient Expansion+FFF model, a FT Blur model, a FT GN model, a FT SP model, and a FT All model. Each model underwent a ten trial test for each of an undistorted CIFAR-10 dataset, the CIFAR-10 dataset with a blur distortion applied at three different intensities, the CIFAR-10 dataset with a SP distortion applied at three different intensities, the CIFAR-10 dataset with a GN distortion applied at three different intensities, and the CIFAR-10 dataset with a SE blur at three different intensities. Graph 1400 also shows the average accuracy of all of the tests for each model.

The results shown in FIG. 13 and FIG. 14, show that SRC models may have a performance ceiling as compared to the traditional fine-tuned model for specific distortions. While fine-tuning on a specific distortion lead to improved performance on that corresponding perturbation the results also show no significant increase, or even a decline, in performance on other distortions. For example, for the MNIST model fine-tuned on blur which achieved optimal blur performance ranging from 96%-76% across corresponding blur intensities 2 to 6, while performance on different distortions was below the baseline. Interestingly, when the MNIST model was fine-tuned on GN or SP, there was a remarkable degree of transfer learning to other distortions; all fine-tuned models for CIFAR-10 also demonstrated this high degree of transfer. The FT models may have been the most accurate models for their respective domain (e.g. the FT Blur performed best for that distortion), however, the SRC model outperformed the FT models on untrained distortions where there was little transfer learning. So while FT models may have improved performance for the specific distortion they are fine tuned for, this can only be achieved with a significantly higher degree of training. For example, the specialized FT models required at least ten epochs on a fine tuning data set that contained seven times the number of training examples as in the original training set (one partition undistorted and 6 partitions of varying degrees of distortions). As a result, at least one particular advantage of SRC models is that they provide a more efficient approach for increasing model robustness when specifics of anticipated distortions are unknown, which is likely to be the case in many “real-world” applications of neural network models, not only for image recognition but for a wide variety of goals and tasks.

The spatial gradient of convolutional filters may be examined and can be used as a metric for filter quality. For example, by inspecting the quality of filters across all convolutional blocks in the network the quality of the CNN can be determined. One way to achieve this is by taking the pixel-wise spatial gradient of all filters in a given layer and fit a Gaussian probability distribution to their values, creating a probabilistic representation for the filter gradients in each convolutional layer. This type of weight analysis can be applied to the convolutional filters of an SRC model according to example embodiments to further investigate and understand why the SRC improves model performance. By examining the properties, such as but not limited to the variance, of the Gaussian probability distribution, to understand the estimated quality of the convolutional blocks. For example, a narrow distribution may indicate many repeated filters while a wider distribution may indicate a large variety of filters. The variability may enable rich feature extraction that may be beneficial for classification.

Table 1500 shows the standard deviation of spatial gradient variance across a baseline model, a Baseline+SRC model, and a Baseline+Gradient Expansion (“GradExp”) model. Furthermore, Table 1500 shows the results for the first convolution layer (C1) and the second convolution layer (C2), respectively. Both the SRC and GradExp models increase variance of the spatial gradient, however, only the SRC model showed a performance increase as well. This may indicate that SRC models produce more diverse and robust feature extractors through local activation patterns within the network and which may be one of the reasons why sleep-like replay is capable of improving model performance across distortions.

Further tests may be performed to further examine the effect filter spatial gradient magnitude variance has on model performance. For example, the spatial gradients of convolutional filters from the baseline model can be artificially expanded to approximate distribution of those in the SRC model. This can be done by choosing a set of hyperparameters (α₁ . . . , α_{L}) and increase the absolute value of all filter elements by that amount. To account for layer specific weigh statistics, different α₁ values for each layer can be selected to approximate changes observed following

$$SRC : W ( l ) = \{ \begin{matrix}W ( l ) + {α}_{l} , & if W ( l ) \\ W ( l ) - {α}_{l} , & otherwise\end{matrix} .$$

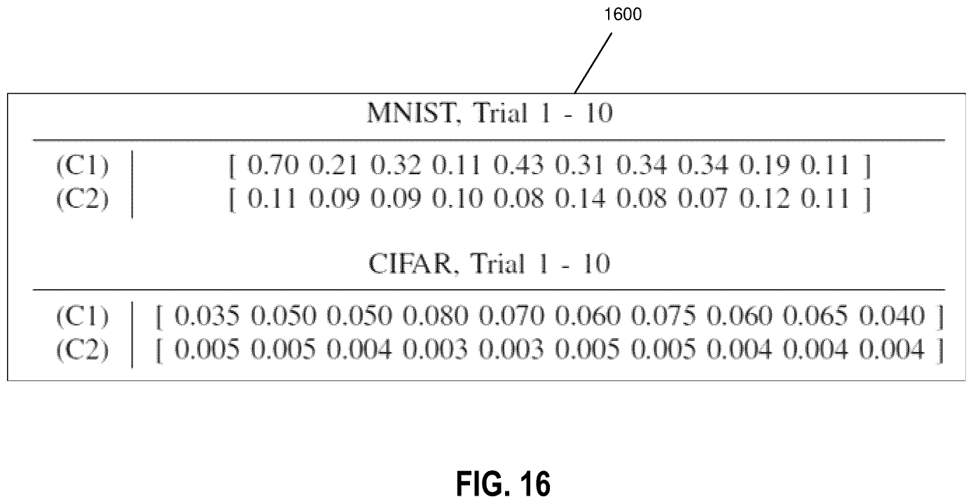

FIG. 16 shows Table 1600 that lists the hyperparameters from 10 random trials each for MNIST and CIFAR-10. Once again C1 and C2 refer to results for the first and second convolution layer respectively.

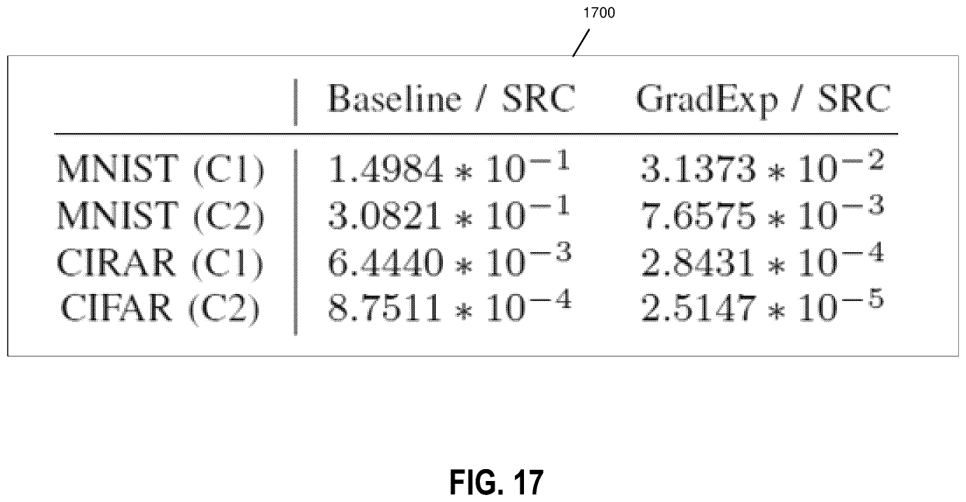

Another test, that can be used to ensure that the increase of hyperparameters generates Gradient Expansion models have different spatial gradient distributions from our baseline model yet are similar to SRC models. This test may measure the KL divergenec of the convolutional filter's spatial gradient distributions for baseline vs. SRC and SRC vs. GradExp models. Table 1700 of FIG. 17 shows example KL divergence values between the baseline and SRC models, as well as the GradExp and SRC models, according to example embodiments. C1 and C2 refer to the results for the first and second convolution layers respectively. Table 1700 shows a relatively high KL divergence between the baseline and SRC, which may signify that SRC is meaningfully modifying filters, and conversely, a relatively low KL divergence between SRC and GradExp models may indicate that the artificially generated spatial gradients are statistically similar to those achieved through SRC.

Different versions of gradient models can be tested accros distortion intensities for both MNIST and CIFAR-10. For example, a test may expand convolutional filter gradients exclusively, whereas a second may apply Feedforward Fitting (FFF) to the network head following filter gradient expansion to allow the decision layers to acclimate to the new feature extractors.

Another way to gain a deeper qualitative and quantitative understanding of how SRC may impact a network, is to analyze the performance of the model by utilizing Gradient-weighted Class Activation Mapping (Grad-CAM). Grad-CAM is a visualization technique that creates an attention map for a given input to identify what the network focuses on. It operates by supplying an image as input and performing a forward pass followed by the calculation of gradients with respect to a given output label. Gradient values can then be used to weight final convolutional activations (which maintain their spatial relevance), the intuition being more important features will have higher gradient values. This approach develops a notion of what input regions the network is attending to.

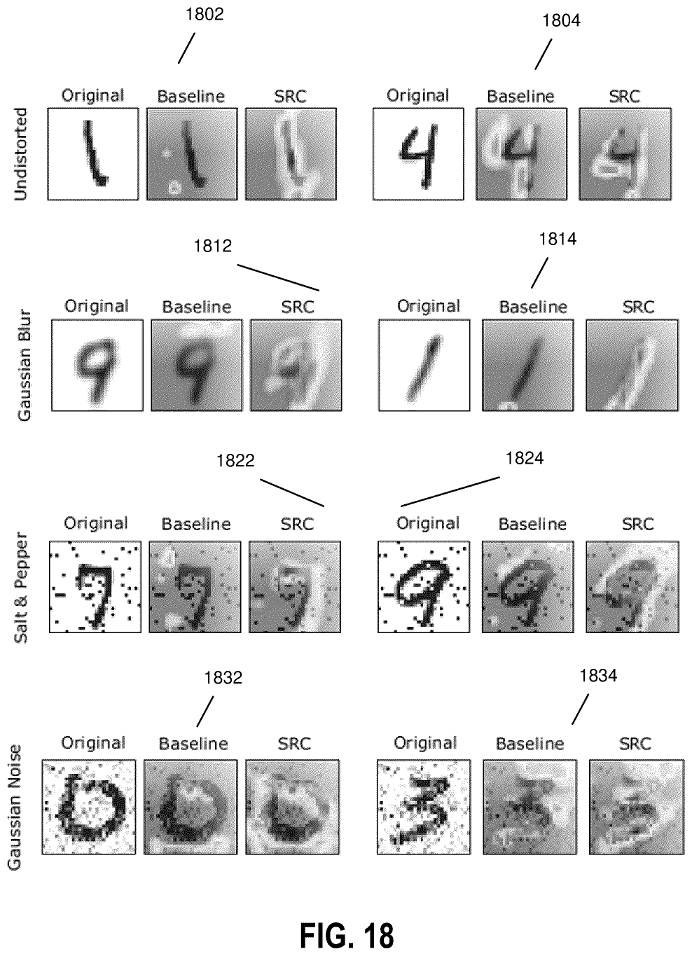

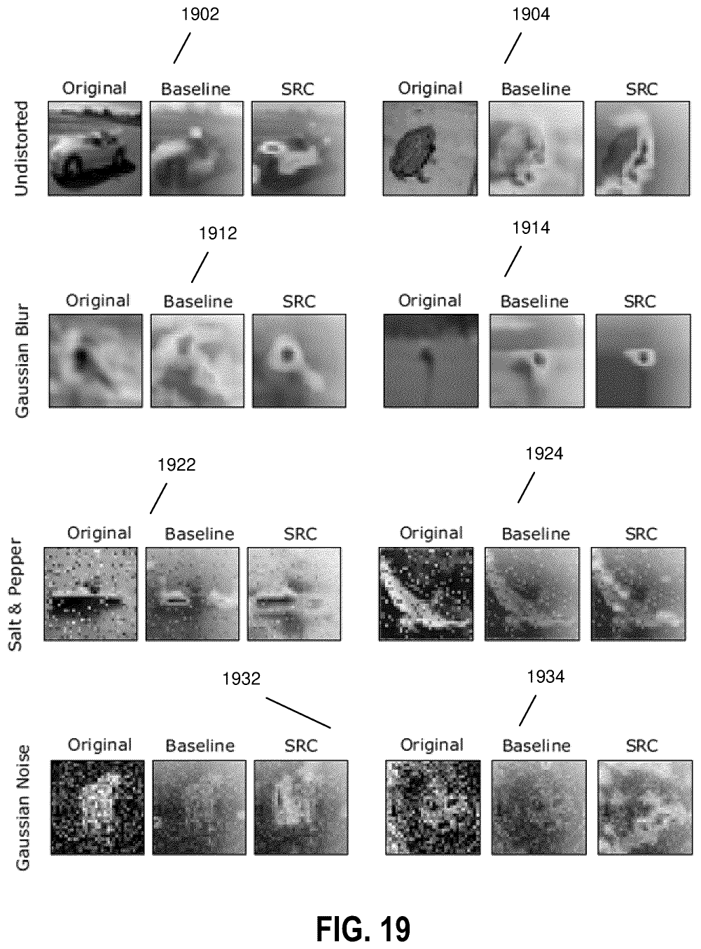

FIG. 18 and FIG. 19 show Grad-CAM visualizations that enable the observation of improvements in attention as a result of SRC. FIG. 18 shows original MNIST images as well as the Grad-CAM visualizations for different models for when the MNIST is undistorted and when different distortions are applied. Image 1802 shows an undistorted MNIST image and the Grad-CAM visualizations of the baseline model and a SRC model. Similarly, image 1804 shows an undistorted MNIST image and the Grad-CAM visualizations of the baseline model and a SRC model. Image 1812 shows a MNIST image with a blur distortion applied and the Grad-CAM visualizations of the baseline model and a SRC model. Image 1814 shows a MNIST image with a blur distortion applied and the Grad-CAM visualizations of the baseline model and a SRC model. Image 1822 shows a MNIST image with a salt and pepper distortion applied and the Grad-CAM visualizations of the baseline model and a SRC model. Image 1824 shows a MNIST image with a salt and pepper distortion applied and the Grad-CAM visualizations of the baseline model and a SRC model. Image 1832 shows a MNIST image with a gaussian noise distortion applied and the Grad-CAM visualizations of the baseline model and a SRC model. Image 1834 shows a MNIST image with a gaussian noise distortion applied and the Grad-CAM visualizations of the baseline model and a SRC model. The results depicted in FIG. 18 display that SRC improves attention quality over the baseline model for performance for MNIST datasets, even when different distortions are applied.

FIG. 19 shows original CIFAR-10 images as well as the Grad-CAM visualizations for different models for when the CIFAR-10 is undistorted and when different distortions are applied. Image 1902 shows an undistorted CIFAR-10 image and the Grad-CAM visualizations of the baseline model and a SRC model. Similarly, image 1904 shows an undistorted CIFAR-10 image and the Grad-CAM visualizations of the baseline model and a SRC model. Image 1913 shows a CIFAR-10 image with a gaussian blur distortion applied and the Grad-CAM visualizations of the baseline model and a SRC model. Image 1914 shows a CIFAR-10 image with a gaussian blur distortion applied and the Grad-CAM visualizations of the baseline model and a SRC model. Image 1922 shows a CIFAR-10 image with a salt and pepper distortion applied and the Grad-CAM visualizations of the baseline model and a SRC model. Image 1924 shows a CIFAR-10 image with a salt and pepper distortion applied and the Grad-CAM visualizations of the baseline model and a SRC model. Image 1932 shows a CIFAR-10 image with a gaussian noise distortion applied and the Grad-CAM visualizations of the baseline model and a SRC model. Image 1934 shows a CIFAR-10 image with a gaussian noise distortion applied and the Grad-CAM visualizations of the baseline model and a SRC model. The results depicted in FIG. 19 display that SRC improves attention quality over the baseline model for performance for CIFAR-10 datasets, even when different distortions are applied. FIG. 18 and FIG. 19 show that in both the MNIST and CIFAR contexts, the SRC model was able to better overlap with the original image input as compared to the baseline model, which often attended to seemingly random pixels. Importantly, is that this improvement of performance of the SRC model was observed not only for the undistorted images but also for the imaged with different distortions applied. The SRC model was able to cut through with the attention heat map taking the shape of the original digit, which indicates that the network is focusing on the relevant features as opposed to irrelevant noise.

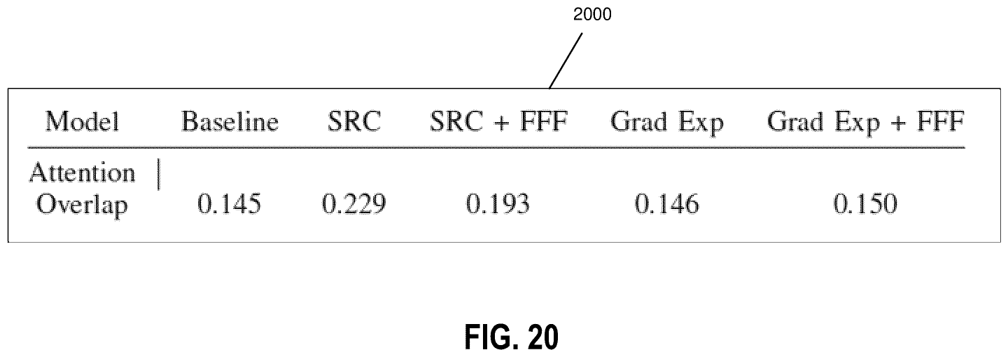

The results of the attention improvements can be quantified in different ways, for example, a rudimentary metric may be constructed in which a pixel wise map of the original digit is developed where 1's are assigned to input locations that correspond with nonzero pixel value and 0's everywhere else which may be followed by a cosine similarity between the mask and the attention vector output by Grad-CAM. With this type of metric, Values close to 1 indicate a large overlap between the clean input image and the network's attention while values near 0 signify a misplaced network focus. Further, this metric may be averaged across different trials of models where different distortion/intensity combinations were applied. Applying this type of metric to the tests described that used example embodiments, the amount of attention overlap and the original undistorted input digit was significantly higher for the model that underwent SRC when compared to the baseline or GradExp models. This indicates that the nontrivial selective filter gradient enhancement provided by SRC can improve convolutional filter quality and focus, even in the presence of meaningful perturbation, which increased overall model performance as compared to at least baseline and GradExp models. Table 2000 in FIG. 20 shows an exemplary Grad-CAM attention overlap metric for different models including SRC models according to example embodiments. Table 2000 shows that the SRC models (both SRC and SRC+FFF) metric values are closer to 1 than are the other models (baseline, Grad Exp, and Grad Exp+FFF). Models that utilize SRC not only increase attention overlap as compared to baseline, but also do so while offering increased performance over other models such as GradExp models.

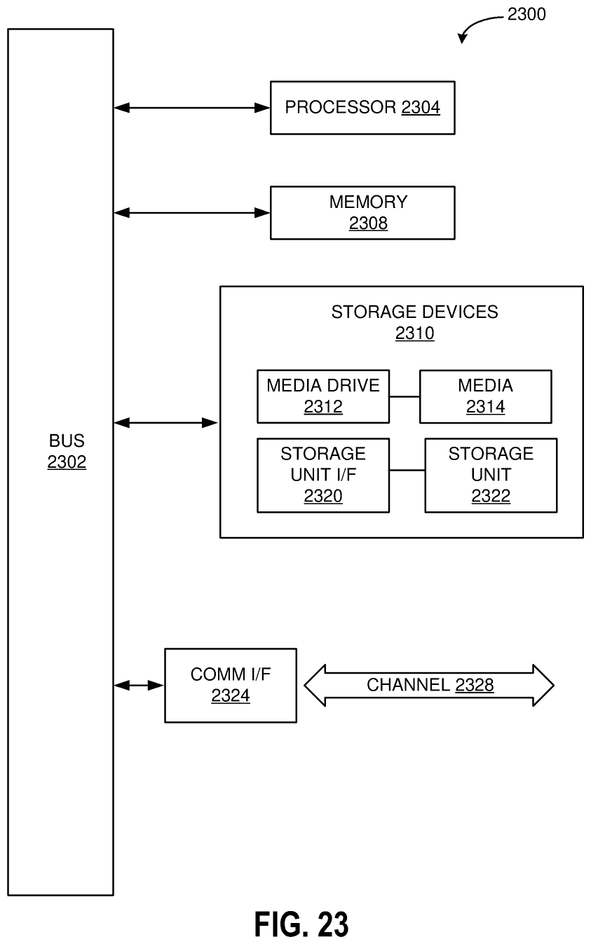

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 23. Various embodiments are described in terms of this example-computing component 2300. After reading this description, it will become apparent to a person skilled in the relevant art how to implement the application using other computing components or architectures.

Referring now to FIG. 23, computing component 2300 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 2300 might also represent computing capabilities embedded within or otherwise available to a given device. For example, a computing component might be found in other electronic devices such as, for example, portable computing devices, and other electronic devices that might include some form of processing capability.

Computing component 2300 might include, for example, one or more processors, controllers, control components, or other processing devices. This can include a processor, and/or any one or more of the components making up a user device, a user system, and a non-decrypting cloud service. Processor 2304 might be implemented using a general-purpose or special-purpose processing engine such as, for example, a microprocessor, controller, or other control logic. Processor 2304 may be connected to a bus 2302. However, any communication medium can be used to facilitate interaction with other components of computing component 2300 or to communicate externally.

Computing component 2300 might also include one or more memory components, simply referred to herein as main memory 2308. For example, random access memory (RAM) or other dynamic memory, might be used for storing information and instructions to be executed by processor 2304. Main memory 2308 might also be used for storing temporary variables or other intermediate information during execution of instructions to be executed by processor 2304. Computing component 2300 might likewise include a read only memory (“ROM”) or other static storage device coupled to bus 2302 for storing static information and instructions for processor 2304.

The computing component 2300 might also include one or more various forms of information storage mechanism 2310, which might include, for example, a media drive 2312 and a storage unit interface 2320. The media drive 2312 might include a drive or other mechanism to support fixed or removable storage media 2314. For example, a hard disk drive, a solid-state drive, a magnetic tape drive, an optical drive, a compact disc (CD) or digital video disc (DVD) drive (R or RW), or other removable or fixed media drive might be provided. Storage media 2314 might include, for example, a hard disk, an integrated circuit assembly, magnetic tape, cartridge, optical disk, a CD or DVD. Storage media 2314 may be any other fixed or removable medium that is read by, written to or accessed by media drive 2312. As these examples illustrate, the storage media 2314 can include a computer usable storage medium having stored therein computer software or data.

In alternative embodiments, information storage mechanism 2310 might include other similar instrumentalities for allowing computer programs or other instructions or data to be loaded into computing component 2300. Such instrumentalities might include, for example, a fixed or removable storage unit 1722 and interface 2320. Examples of such storage units 2322 and interfaces 2320 can include a program cartridge and cartridge interface, a removable memory (for example, a flash memory or other removable memory component) and memory slot. Other examples may include a PCMCIA slot and card, and other fixed or removable storage units 2322 and interfaces 2320 that allow software and data to be transferred from storage unit 1722 to computing component 2300.

Computing component 2300 might also include a communications interface 2324. Communications interface 2324 might be used to allow software and data to be transferred between computing component 2300 and external devices. Examples of communications interface 2324 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 2324 may be carried on signals, which can be electronic, electromagnetic (which includes optical) or other signals capable of being exchanged by a given communications interface 2324. These signals might be provided to communications interface 2324 via a channel 2328. Channel 2328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 2308, storage unit 2322, media 2314, and channel 2328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 2300 to perform features or functions of the present application as discussed herein.

### Artificial Neural Networks Trained With Limited/Imbalanced or Partial Data

As alluded to above, the performance of deep learning methods has been correlated with the size of training datasets. For example, deep learning methods have shown considerable performance when trained with large datasets. However, existing techniques generally fail in low training data conditions. For example, the performance of existing techniques degrades when training data is limited. Additionally, training datasets are often imbalanced, with some categories within the training datasets occurring more frequently than others, resulting in reduced accuracy for ANNs. Several methods have been proposed to overcome these limitations. These methods include data augmentation, pretraining on other datasets, or alternative architectures such as neural tangent kernel. However, these approaches do not address the fundamental question of how to make overparameterized deep learning networks learn to generalize from small datasets without overfitting.

In contrast, the human brain demonstrates the ability to learn quickly from just a few examples. Sleep has been shown to play an important role in memory consolidation in biological systems. Two critical components which are believed to underlie memory consolidation during sleep are: (1) the spontaneous replay of memory traces; and (2) local unsupervised synaptic plasticity that restricts synaptic changes to relevant memories only. During sleep, replay of recently learned memories along with relevant old memories enables the network to form stable long-term memory representations and reduces competition between memories.

The idea of replay has been explored in machine learning to enable continual learning. However, spontaneous unsupervised replay found in the biological brain and implemented in embodiments of the presently disclosed technology is significantly different compared to explicit replay of past inputs implemented in existing machine learning rehearsal methods. As embodiments of the presently disclosed technology are designed in appreciation of, applying sleep replay principles—such as Sleep Replay Consolidation (SRC)—to ANNs may enhance memory representations and, consequently, improve the performance of machine learning models trained on limited, imbalanced, or partial datasets.

The presently disclosed SRC methodology can be implemented by transforming a neural network from an ANN to a spiking neural network (SNN) and modifying synaptic weights of the neural network by applying a simulated memory replay process to the transformed neural network (i.e., when the ANN is transformed into the SNN), and after applying the simulated memory replay process to the neural network, transforming the neural network from the synaptic weight-modified SNN to a synaptic weight-modified CNN.

Advantages of the presently disclosed approach include, for example, improving accuracy of an ANN when training data is imbalanced/limited or partial.

### A. Algorithm

In accordance with example experiments, examples of the presently disclosed SRC models were evaluated using two well-known datasets, MNIST and Fashion MNIST (FMNIST). For example, during an example experiment, a fully-connected ANN with two hidden layers was first trained on a randomly selected subset of MNIST or FMNIST datasets using backpropagation. Subsequently, an SRC process sleep phase of the presently disclosed technology was implemented. As further discussed below, the ANN trained by limited data was mapped to a SNN with the same architecture. The SNN's activity was driven by randomly distributed Poisson spiking input that reflected average inputs observed in the training dataset. Local Hebbian-type plasticity was implemented to modify weights during the sleep phase (i.e., synaptic strength was increased if presynaptic activation was followed by postsynaptic activation and reduced if postsynaptic activation occurred without presynaptic activation). After the sleep phase, the SNN was remapped back to an ANN. In some implementations, SRC may be applied after each new task training to avoid catastrophic forgetting.

### B. Results

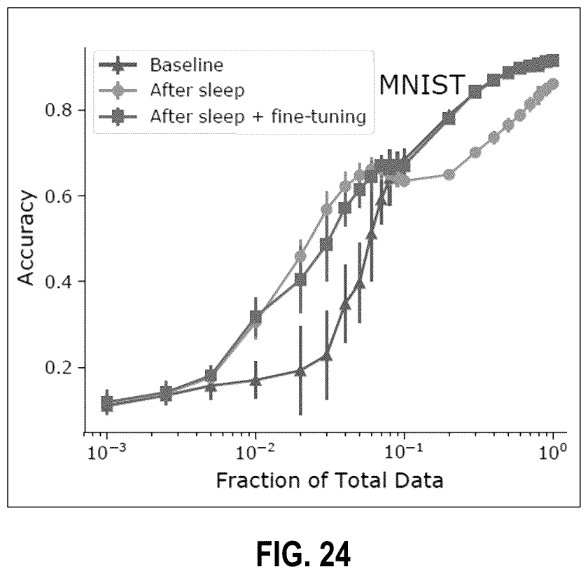

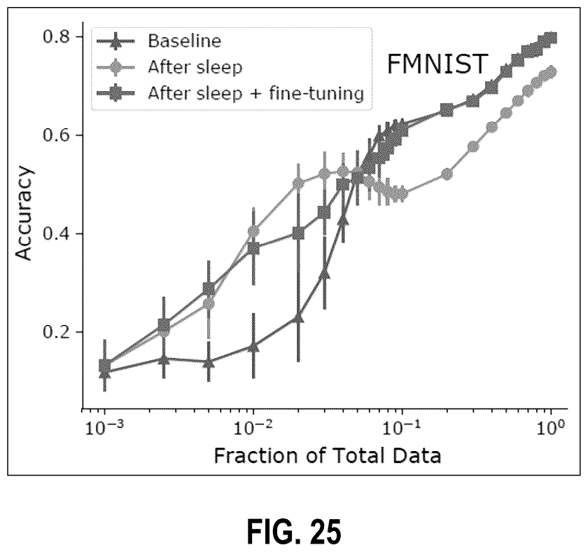

FIG. 24 and FIG. 25 are graphs illustrating the accuracy of the neural network trained with the MNIST dataset and the neural network trained with the FMNIST dataset, respectively, with mean (lines) and standard deviation (error bars) across ten (10) trials. The Y-axis of the graphs of FIG. 24 and FIG. 25 illustrates accuracy and the X-axis of the graphs of FIG. 24 and FIG. 25 illustrates the fraction of total data used by showing the log of the relative amount of data used for training (e.g., 0.01=1% of data). The “baseline” line of the graphs of FIG. 24 and FIG. 25 illustrates accuracy of the models after supervised training but before sleep. The “after sleep” line of the graphs of FIG. 24 and FIG. 25 illustrates accuracy of the neural networks after supervised training and sleep. The “after sleep+fine-tuning” line of the graphs of FIG. 24 and FIG. 25 illustrates accuracy of the neural networks after supervised training, sleep, and fine tuning of the neural network.

When an ANN was trained with a full dataset, it achieved an accuracy of over 90%. However, when less than 10% of the dataset's total data was used during training of the ANN, accuracy significantly declined as shown by the “baseline” line in FIG. 24 and FIG. 25. When 0.5% to 10% of the dataset's total data was used for ANN training, the subsequent application of SRC resulted in a substantial (20-30%) increase in accuracy for both the MNIST and FMNIST datasets as shown by the “after sleep” line in FIG. 24 and FIG. 25. Increasing the training duration (e.g., by increasing the number of epochs), increased performance of the ANN before sleep but a significant performance gain after sleep remained.

As further discussed below (see, e.g., section “Confusion Matrices”), analysis of a confusion matrix illustrated that networks trained with limited data may exhibit biases towards a few classes. For example, when 3% of MNIST data was used in training, classes 0, 2, 5, and 6 were all classified as 0. However, after application of SRC, classes 0, 2, and 6 were classified correctly. Succinctly, the model exhibited a more balanced response after the application of SRC.

While performance improved when there was limited training data, in examples, a slight (10-15%) decrease in performance may occur when more than approximately 10% of the total data of a dataset is employed for ANN training. As shown by the “after sleep+fine-tuning” line in FIG. 24 and FIG. 25, this decrease in performance may be mitigated by fine-tuning the ANN after application of SRC by using the original (limited) training data. Thus, by incorporating both the application of SRC and fine-tuning, example experiments were able to maintain performance on models trained with the full dataset while still achieving performance gains on models trained with limited data.

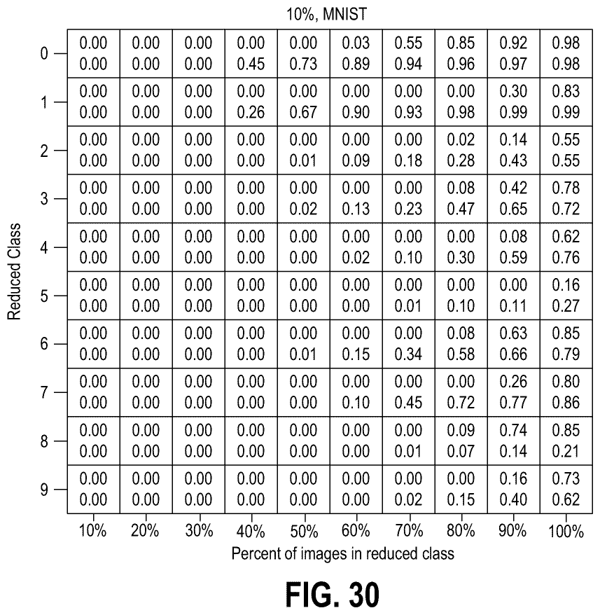

In addition, as further discussed below (see, e.g., section “Imbalanced Data”), examples of the presently disclosed SRC models were examined for accuracy when a significant class imbalance was introduced to a training dataset by selectively reducing the number of training examples used for certain classes. FIG. 30 illustrates that class-wise model performance may be more robust to data reduction for some classes when compared to others. After application of SRC, most classes showed a positive improvement in class-wise accuracy. Thus, the sleep phase (i.e., the application of SRC) proved effective in increasing model accuracy on underrepresented classes while preserving accuracy on well-trained classes.

Moreover, as further discussed below, analysis of synaptic weights illustrates that the presently disclosed SRC methodology may increase strength for a small fraction of critical synapses, while many other synapses may be weakened. Thus, the overall accuracy increase after application of SRC may at least partially be a result of increasing the sparsity of responses.

The presently disclosed approach illustrates a potential synaptic weight dynamics strategy employed by the human brain during sleep to enhance memory performance when training data is limited or imbalanced. Applied to ANNs, sleep-like replay may improve performance in a completely unsupervised manner, requiring no additional data, and may be applied to already trained models.

### C. Task Protocols

As alluded to above, it is well understood that deep learning models may require significant amounts of data to achieve top tier performance and that performance degrades when data is limited. Example experiments disclosed herein illustrate the effects of applying SRC to undertrained and underperforming ANNs using two datasets: MNIST and FMNIST. The MNIST dataset consists of handwritten numbers (0-9) each belonging to its own class while FMNIST consists of 10 classes of Zalando's article images. Together, the MNIST and FMNIST datasets are some of the most widely used datasets in machine learning making them good candidates to illustrate the presently disclosed SRC models' ability to improve performance in data limited contexts. Each dataset consists of 60,000 training images and 10,000 testing images.

In an example experiment, an ANN was trained on a randomly selected subset of the full MNIST and FMNIST datasets (0.1%-100%) and subsequently a sleep stage (SRC) was applied. Importantly, the number of images per class may vary significantly when a small fraction of data is used which may cause preferential performance on over represented classes and diminished performance on underrepresented classes. Therefore, in some simulations the same exact number of images was selected for each class. To further test the effect of SRC on ANNs trained with imbalanced training datasets, the number of images in one selected class was reduced, keeping the number of images for all other classes equal and fixed.

### D. Network Details

The same network architecture and training parameters were used in all testing simulations of the presently disclosed technology. A fully-connected feedforward model with 2 hidden layers consisting of 1200 nodes each followed by a classification layer with 10 output neurons was used. While the network was operating in an ANN regime, hidden layers leveraged ReLUs nonlinearities. The model was trained using hidden layer dropout and a binary cross entropy loss with weights being modified using a standard stochastic gradient decent optimizer. Neurons in the network operated without a bias, which aided in the conversion to a spiking neural network (with Heaviside-activation function) during the sleep stage. When the ANN was converted to an SNN for sleep, all activation functions were replaced with the Heavyside thresholding function to enable spiking behavior while the weight matrices remained thereby preserving the structure developed by ANN training. Five (5) epochs of training was used in the main analysis and the results were verified using ten (10) and fifty (50) epoch of training. A summary of the network's parameters are shown in Table 2 below.

TABLE 2
Neural Network Parameters

| | MNIST/FMIST |
|---|---|
| Arch. Size | 1200, 1200, 10 |
| Learn Rate | 0.065 |
| Epochs | 5 (10, 50) |
| Dropout | 0.25 |

### E. Sleep Replay Consolidation (SRC) Algorithm

The intuition behind SRC is that a period of off-line, noisy activity may reactivate network nodes that represent tasks trained while awake. If network reactivation is combined with unsupervised learning, SRC may strengthen necessary pathways and weaken unnecessary pathways through the network. Even if new classes are undertrained, information is already present in the synaptic weight matrices and SRC may augment this information using sleep-like replay.

Table 3 below shows an example pseudocode algorithm of the presently disclosed SRC process.

TABLE 3
SRC ALGORITHM

| 1: | procedure SLEEP(nn, I, scales, thresholds) | | [symbol] I is input |
|---|---|---|---|
| 2: | | Initialize v (voltage) = 0 vectors for all neurons | |
| 3: | | for t ← 1 to Ts do | [symbol] Ts - duration of sleep |

| | |
|---|---|
| 4: | S(1) ← Convert input I to Poisson-distributed spiking activity |
| 5: | S = ForwardPass(S, v, W, scales, thresholds) |
| 6: | W= BackwardPass(S, W) |

| 7: | | end for | |
|---|---|---|---|
| 8: | end procedure | | |
| 9: | procedure FORWARDPASS(S, v, W, scales, threshold) | | |
| 10: | | for I ← 2 to n do | [symbol] n - number of layers |

| 11: | α ← scales(I − 1) | |
|---|---|---|
| 12: | β ← threshold(I) | |
| 13: | v(I) ← v(I) + (α * W(I, I − 1) * S(I − 1)) | [symbol] W(I, I − 1) - weights |
| 14: | S(I) ← 0s | |
| 15: | S(I)(v(I) > β) ← 1 | [symbol] Propagate spikes |
| 16: | v(I)(v(I) > β) ← 0 | [symbol] Reset spiking voltages |

| 17: | | | |
|---|---|---|---|
| 18: | | end for | |
| 19. | return S | | |
| 20: | end procedure | | |
| 21: | procedure BACKWARD PASS(S, W) | | |
| 22: | | for I ← 2 to n do | [symbol] n - number of layers |

| | |
|---|---|
| 23: | W(I, I − 1)i,j ← {W(I, I − 1)i,j + inc∀ i,j where S(I)j = 1 & S(I − 1)i = 1 W(I, I |

− 1)i,j − dec∀ i,j where S(I)j = 1 & S(I − 1)i = 0

| | | |
|---|---|---|
| 24: | W(I, I − 1)i,j else | [symbol] STDP |

| | |
|---|---|
| 25. | return W |
| 26. | =0 |

In the Main procedure, a network is first initialized (e.g., within a PyTorch environment). Next, a task is presented to the network and the network is trained via backpropagation and stochastic gradient descent. After this supervised training phase, SRC is implemented within the same environment. During the SRC phase, the network's activation function may be replaced by a Heaviside function and weights may be scaled by a maximum activation in respective layers observed during the prior training. The scaling factors and layer-wise Heaviside activation thresholds may be determined based on a preexisting algorithm aimed at ensuring the network maintains reasonable firing activity in the layers of the network. This algorithm may apply a scaling factor to respective layers based on a maximum input to that layer and a maximum weight in that layer.

During the SRC phase, a forward pass may be implemented wherein noisy input is created and fed through the network in order to get activity (e.g., spiking behavior) of some or all the layers. Following the forward pass, a backward pass may be used to update synaptic weights. To modify network connectivity during sleep, an unsupervised simplified Hebbian-type learning rule may be used. The Hebbian-type learning rule may be implemented as follows: a weight is increased between two nodes when both presynaptic and postsynaptic nodes are activated (i.e., input exceeds Heaviside activation function threshold); and a weight is decreased between two nodes when the postsynaptic node is activated but the presynaptic node is not (in this case, another presynaptic node may be responsible for activity in the postsynaptic node). After running multiple steps of this unsupervised training during sleep, the final weights may be rescaled again (e.g., by removing the original scaling factor), the Heaviside-type activation function may be replaced by ReLU, and testing or further supervised training on new data may be performed. This all may be implemented by a SRC function call after each new task training. The exact parameters dictating neuronal firing thresholds and synaptic scaling factors may differ for each dataset and each architecture. These parameters may be determined using a genetic algorithm aimed at maximizing performance on the training set. In some implementations, these parameters may be optimized based on ideal neuronal firing rates observed during sleep.

During the sleep phase, to ensure network activity, the input layer of the network may be activated with noisy binary (0/1) inputs. In input vectors (i.e., for forward SRC passes), the probability of assigning a value of one (1) (e.g., bright or spiking) to a given element (e.g., input pixel) may be taken from a Poisson distribution with mean rate calculated as a mean intensity of that input element across all the inputs observed during all of the preceding training sessions. Thus, for example, a pixel that was typically bright in all training inputs would be assigned a value of one (1) more often than a pixel with lower mean intensity.

### F. Confusion Matrices

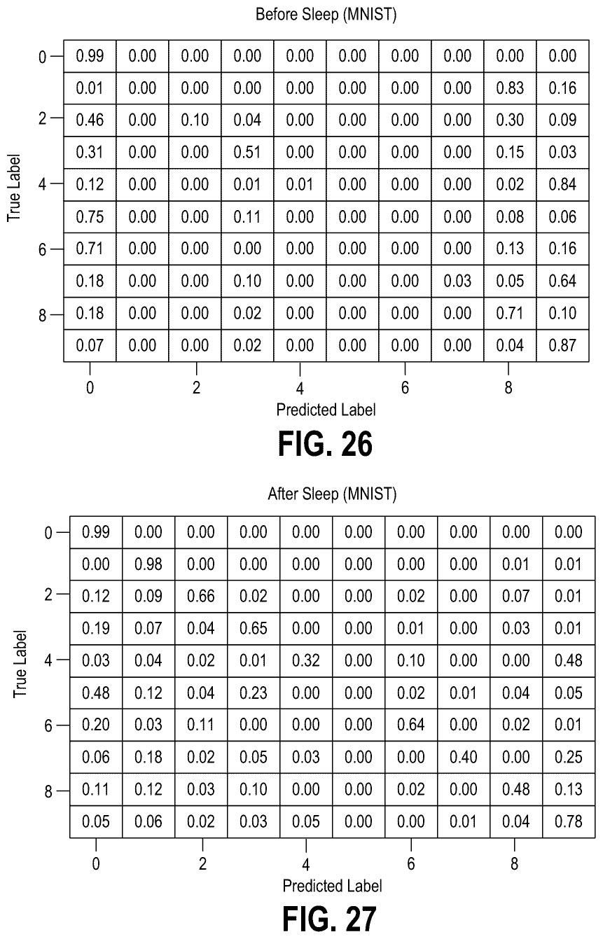

FIG. 26 shows a resulting confusion matrix of a neural network trained with the MNIST dataset before the sleep phase, and FIG. 27 shows a resulting confusion matrix of the neural network after the sleep phase. The value in each cell of FIGS. 26 and 27 indicates the fraction of images given a true label that were classified as a given predicted label by the neural network. Of the full MNIST dataset for training, a 3% subset was used. Other training parameters of the neural network are as described in Table 2 above. As shown in FIG. 26, at the end of the training phase, classes 0, 3, 8, and 9 were predicted with reasonable accuracy, at 0.99, 0.51, 0.71, and 0.87 accuracy, respectively. The remaining classes were predicted highly inaccurately and were incorrectly classified as class 0, 8, or 9 in most cases by the network. Overall, the prediction accuracy was very low after the training phase but before the sleep phase, at 0.32. After the sleep phase, the accuracy of most classes improved as shown in FIG. 27, yielding an overall accuracy of 0.60.

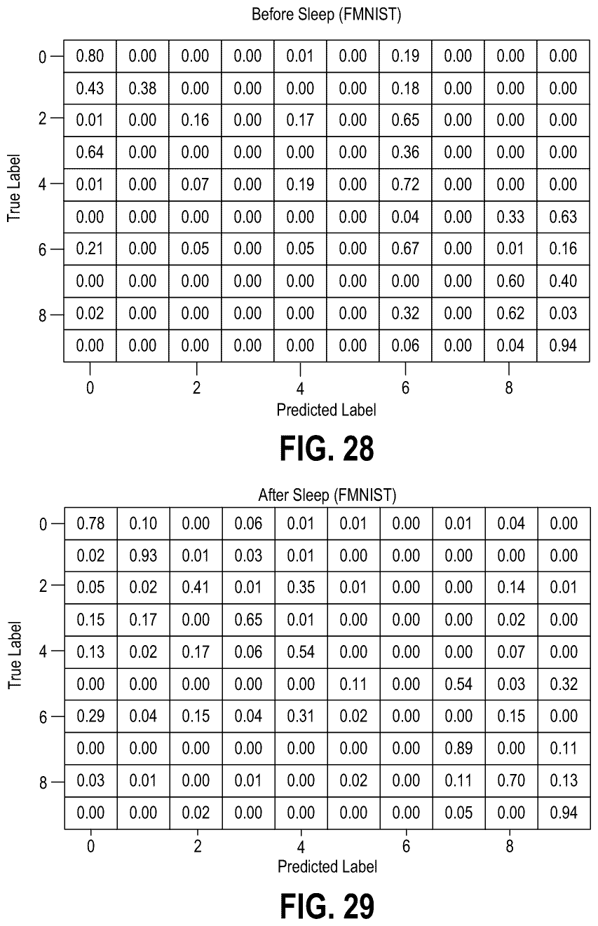

Similarly, FIG. 28 and FIG. 29 show a resulting confusion matrix of the neural network using 3% of the FMNIST dataset before the sleep phase and after the sleep phase, respectively. The value in each cell of FIGS. 28 and 29 indicates the fraction of images given a true label that were classified as a given predicted label by the neural network. Before the sleep phase, the overall accuracy was 0.38, with only classes 0, 6, 8, and 9 being classified with reasonable accuracy as shown in FIG. 28. After the sleep phase, the accuracy of classes increased resulting in an overall accuracy of 0.59 as shown in FIG. 29.

### G. Imbalanced Data

In another example experiment, the effect of sleep when training data is imbalanced (i.e., data is more limited for some classes than for others) was analyzed. In such scenarios, a neural network may ordinarily become biased towards classes with more training data at the expense of classes with less data. However, as detailed below, examples of the presently disclosed SRC models may recover performance in such low data classes.

FIG. 30, for example, illustrates an analysis when a 10% subset of the MNIST training data was used and when the number of images used for one of the classes during training was further limited. Accordingly, for this analysis a 10% subset of the MNIST dataset was first randomly selected, specifically ensuring that each class had the same number of images. Then, for one selected “imbalanced” class, only a fraction of that training data subset was included, while other classes were trained on all images in the 10% subset. The fraction of images in the low data class ranged from 10% to 100% of the 10% subset of training data (i.e., from 1% to 10% of the full MNIST dataset). Each cell in FIG. 30 includes a top value and a bottom value. The top value in each cell shows the accuracy of a respective class (as indicated on the left side of FIG. 30) with reduced data (as indicated on the bottom of FIG. 30) before sleep, and the bottom value in each cell shows the accuracy of the respective class with reduced data after sleep.

As shown in FIG. 30, some classes were more “resistant” to data reduction. For example, digits “0” showed high classification accuracy when more than 70-80% of the 10% subset was used (i.e., more than 7-8% of the total MNIST dataset), while digit “5” had very low performance even when all data were used (i.e., 10% of the total MNIST dataset). After application of SRC, most classes (except class 8) showed a positive improvement in accuracy when the amount of training data used for the respective class was 40-90% of the 10% subset of the MNIST training data used for the other classes. The magnitude of the gain and the range of data reduction where the gain was observed were varied between digits because of the different sensitivity to data reduction. Similar results (not shown) were observed with the FMNIST dataset.

### H. Analysis of Replay During Sleep

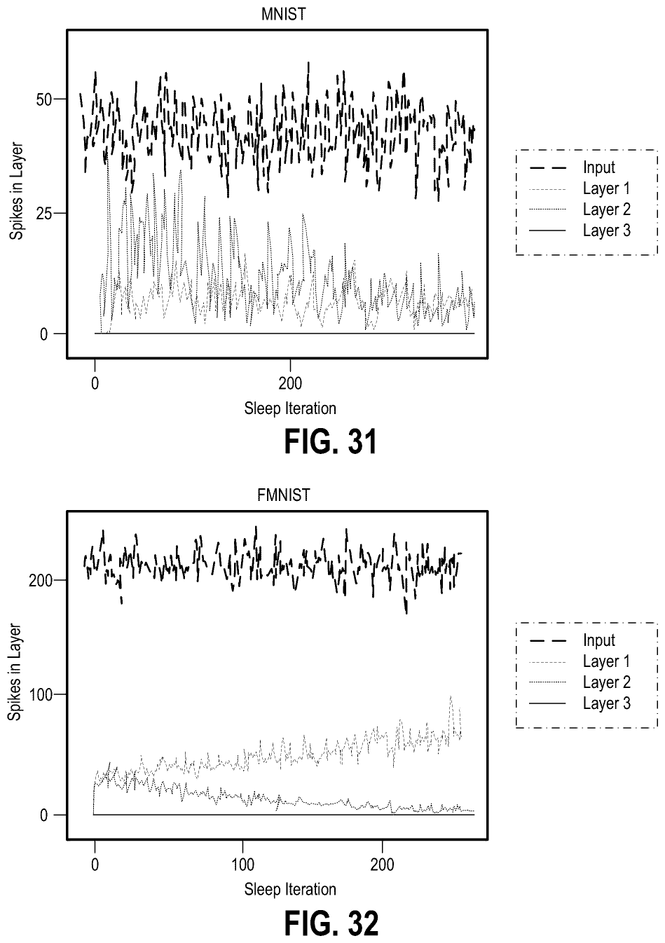

FIG. 31 illustrates a graph of layer-wise activity during SRC for the MNIST trained network and FIG. 32 illustrates a graph of layer-wise activity during SRC for the FMNIST trained network. To better illustrate why SRC is capable of improving undertrained model performance, the sleep stage itself was analyzed. First, network activity was measured by looking at instantaneous layer-wise firing rates. FIG. 31 and FIG. 32 illustrate that all layers, excluding the output, in both the MNIST and FMNIST networks were highly active. The lack of output layer activity along with the previously discussed Hebbian learning rules means the output layer received no modifications during the entirety of SRC. Accordingly, benefits of SRC may be due to hidden layer modifications. In addition, the activity in all layers except the output layer in both the MNIST and FMNIST networks illustrates that the benefits of SRC may be due to enhancing the networks' ability to extract relevant features.

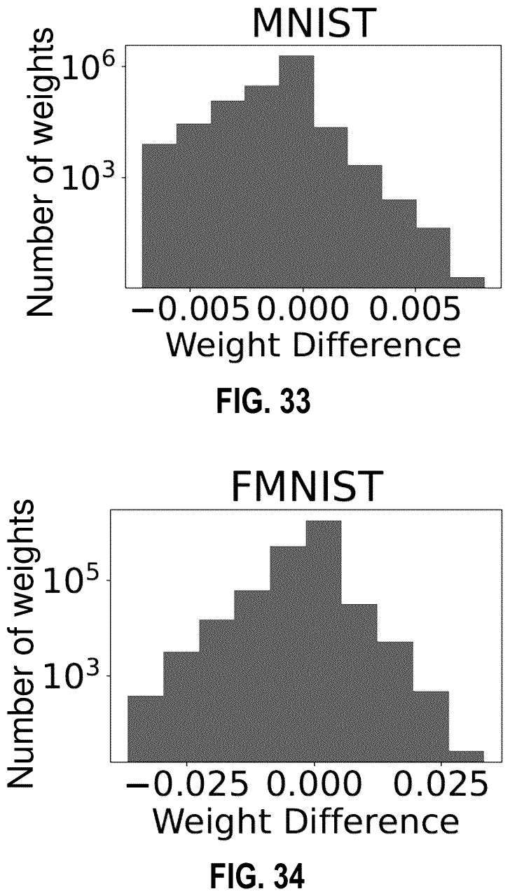

In addition, the magnitude of weight modifications was examined. For example, FIG. 33 shows a histogram of the cumulative weight perturbation each synapse received during sleep for the MNIST trained network and FIG. 34 shows a histogram of the cumulative weight perturbation each synapse received during sleep for the MNIST trained network. Although a small number of critical synapses showed an increase in strength (e.g., illustrated in FIG. 33 and FIG. 34 as positive weight deltas), most synapses decreased their sensitivity (e.g., in FIG. 33 and FIG. 34 the majority of synapses have weight deltas less than zero (0)). Taken together, these results illustrate that SRC may improve feature representations by causing hidden layer neurons to be less sensitive to certain stimuli. This may be intuitively motivated, in a data limited context the training distribution may have many outliers due to the small number of samples thereby causing a model to pick up on irrelevant features only present in a small percentage of examples. SRC may then selectively suppress the strength of certain synapses (e.g., a majority of synapses), while maintaining a few, thereby reducing irrelevant feature sensitivity leading the model to focus on the most common and therefore predictive features.

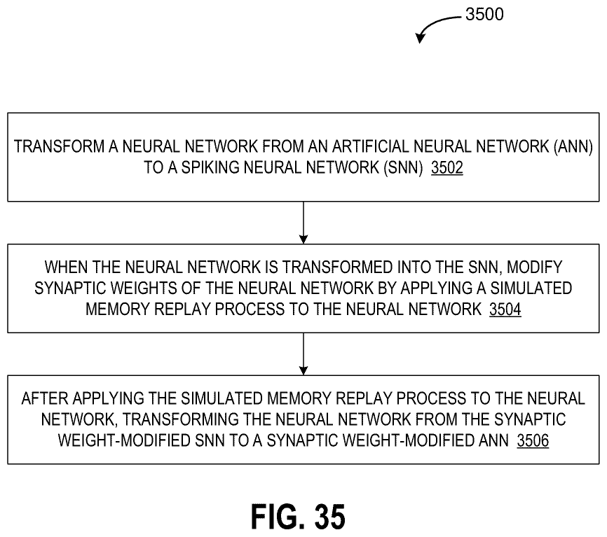

FIG. 35 illustrates an example method 3500 in accordance with the presently disclosed SRC process described above. In certain implementations, the method 3500 may be for increasing accuracy of a neural network trained with a portion of data from a dataset or an imbalanced/limited dataset.

As shown in FIG. 35 (and as described above), operation 3502 may involve transforming a neural network from an artificial neural network (ANN) to a spiking neural network (SNN). In various implementations (and as described above), transforming the neural network from the ANN to the SNN may comprise preserving the (same) network architecture (e.g., neuron and synaptic weight architecture) for the neural network. In various implementations (and as described above), the ANN may comprise a fully-connected ANN.

In various implementations (and as described above) transforming the neural network from the ANN to the SNN may comprise replacing an original activation function of the neural network with a Heaviside function. In certain implementations (and as described above), the original activation function of the neural network may comprise a ReLU activation function.

In various implementations (and as described above), transforming the neural network from the ANN to the SNN may comprise applying layer-wise scale factors to the synaptic weights of the neural network to facilitate activity across layers of the neural network. In certain implementations (and as described above), the layer-wise scale factors may be based on a maximum input to a respective layer of the neural network and a maximum synaptic weight of the respective layer of the neural network.

In various implementations (and as described above), prior to transforming the neural network from the ANN to the SNN, the method 3500 may further comprise: (a) selecting a first portion of data from a dataset with the dataset having a second portion of data that is corrupted, lost, or unusable for training the neural network; and (b) training the neural network with the first portion of data. As described above, the presently disclosed SRC process may improve the accuracy of neural networks trained on limited, imbalanced, and/or partial datasets. In examples, an imbalanced dataset may be a dataset that includes less data (e.g., 90% less data, 80% less data, 50% less data, etc.) for some classes than for others. A neural network may be trained with a portion of data from a dataset for various reasons. For example, training the neural network with the portion of data may be required or desirable when other portions of the dataset are corrupted, lost, and/or unusable for training the neural network (e.g., the other portions are not relevant, include errors, are too imbalanced, etc.). Accordingly, the presently disclosed SRC process may be especially advantageous in these situations.

In various implementations, the method 3500 may further comprise detecting (e.g., prior to selecting the first portion of data from the dataset) the second portion of data is corrupted, lost, or unusable.

As shown in FIG. 35 (and as described above), when the neural network is transformed into the SNN, operation 3504 may involve modifying synaptic weights of the neural network by applying a simulated memory replay process to the neural network.

In various implementations (and as described above), modifying the synaptic weights of the neural network by applying the simulated memory replay process to the neural network may comprise applying a randomly distributed spiking input to the neural network and applying Hebbian-based learning rules to modify the synaptic weights. In certain implementations (and as described above), the randomly distributed spiking input may comprise a randomly distributed Poisson spiking input reflecting average inputs of a training dataset. In certain implementations (and as described above), the Hebbian-based learning rules may comprise: (a) increasing a respective synaptic weight connecting a first neuron (e.g., a pre-synaptic connection into the respective synaptic weight) to a second neuron (e.g., a post-synaptic connection from the respective synaptic weight) when both the first and second neuron are activated; (b) and decreasing the respective synaptic weight when the second neuron is activated and the first neuron is not activated.

In various implementations (and as described above), the simulated memory replay process may comprise activating an input layer of the neural network with noisy binary inputs.

As shown in FIG. 35 (and as described above), after applying the simulated memory replay process to the neural network, operation 3506 may involve transforming the neural network from the synaptic weight-modified SNN to a synaptic weight-modified ANN.

In various implementations (and as described above), transforming the neural network from the synaptic weight-modified SNN to the synaptic weight-modified ANN may comprise removing the layer-wise scale factors from the neural network and replacing the Heaviside function with the original activation function for the neural network.

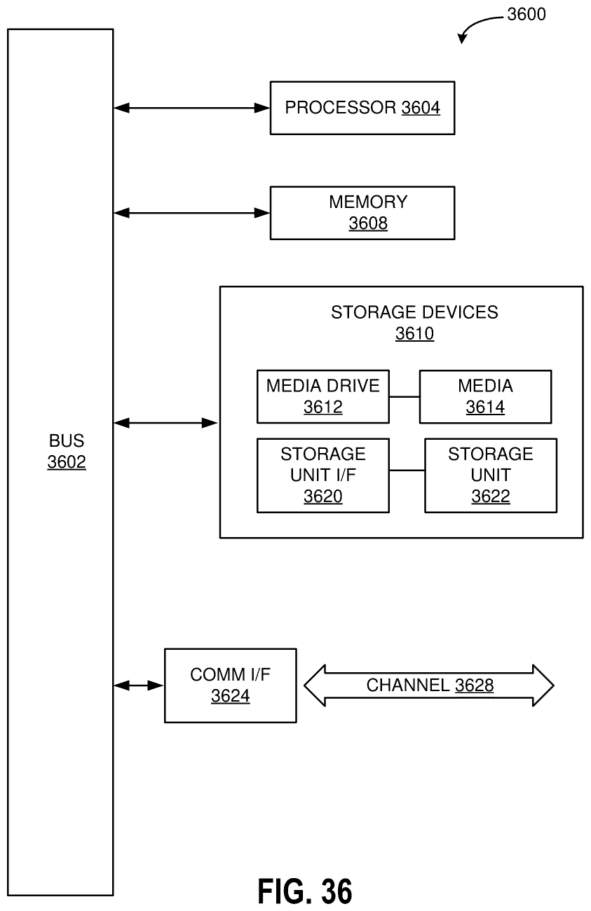

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 36. Various embodiments are described in terms of this example-computing component 3600. After reading this description, it will become apparent to a person skilled in the relevant art how to implement the application using other computing components or architectures.

Referring now to FIG. 36, computing component 3600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 3600 might also represent computing capabilities embedded within or otherwise available to a given device. For example, a computing component might be found in other electronic devices such as, for example, portable computing devices, and other electronic devices that might include some form of processing capability.

Computing component 3600 might include, for example, one or more processors, controllers, control components, or other processing devices. This can include a processor, and/or any one or more of the components making up a user device, a user system, and a non-decrypting cloud service. Processor 3604 might be implemented using a general-purpose or special-purpose processing engine such as, for example, a microprocessor, controller, or other control logic. Processor 3604 may be connected to a bus 3602. However, any communication medium can be used to facilitate interaction with other components of computing component 3600 or to communicate externally.

Computing component 3600 might also include one or more memory components, simply referred to herein as main memory 3608. For example, random access memory (RAM) or other dynamic memory, might be used for storing information and instructions to be executed by processor 3604. Main memory 3608 might also be used for storing temporary variables or other intermediate information during execution of instructions to be executed by processor 3604. Computing component 3600 might likewise include a read only memory (“ROM”) or other static storage device coupled to bus 3602 for storing static information and instructions for processor 3604.

The computing component 3600 might also include one or more various forms of information storage mechanism/devices 3610, which might include, for example, a media drive 3612 and a storage unit interface 3620. The media drive 3612 might include a drive or other mechanism to support fixed or removable storage media 3614. For example, a hard disk drive, a solid-state drive, a magnetic tape drive, an optical drive, a compact disc (CD) or digital video disc (DVD) drive (R or RW), or other removable or fixed media drive might be provided. Storage media 3614 might include, for example, a hard disk, an integrated circuit assembly, magnetic tape, cartridge, optical disk, a CD or DVD. Storage media 3614 may be any other fixed or removable medium that is read by, written to or accessed by media drive 3612. As these examples illustrate, the storage media 3614 can include a computer usable storage medium having stored therein computer software or data.

In alternative embodiments, information storage devices 3610 might include other similar instrumentalities for allowing computer programs or other instructions or data to be loaded into computing component 3600. Such instrumentalities might include, for example, a fixed or removable storage unit 3622 and interface 3620. Examples of such storage units 3622 and interfaces 3620 can include a program cartridge and cartridge interface, a removable memory (for example, a flash memory or other removable memory component) and memory slot. Other examples may include a PCMCIA slot and card, and other fixed or removable storage units 3622 and interfaces 3620 that allow software and data to be transferred from storage unit 3622 to computing component 3600.

Computing component 3600 might also include a communications interface 3624. Communications interface 3624 might be used to allow software and data to be transferred between computing component 3600 and external devices. Examples of communications interface 3624 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 3624 may be carried on signals, which can be electronic, electromagnetic (which includes optical) or other signals capable of being exchanged by a given communications interface 3624. These signals might be provided to communications interface 3624 via a channel 3628. Channel 3628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 3608, storage unit 3622, media 3614, and channel 3628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 3600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
transforming a neural network from an artificial neural network (ANN) to a spiking neural network (SNN);
when the neural network is transformed into the SNN, modifying synaptic weights of the neural network by applying a simulated memory replay process to the neural network; and
after applying the simulated memory replay process to the neural network, transforming the neural network from the synaptic weight-modified SNN to a synaptic weight-modified ANN.

2. The method of claim 1, further comprising:
selecting a first portion of data from a dataset, the dataset having a second portion of data that is corrupted, lost, or unusable for training the neural network; and
before transforming the neural network from the ANN to the SNN, training the neural network with the first portion of data.

3. The method of claim 2, further comprising detecting the second portion of data is corrupted, lost, or unusable.

4. The method of claim 1, wherein transforming the neural network from the ANN to the SNN comprises replacing an original activation function of the neural network with a Heaviside function.

5. The method of claim 4, wherein the original activation function of the neural network comprises a ReLU activation function.

6. The method of claim 4, wherein transforming the neural network from the ANN to the SNN further comprises applying layer-wise scale factors to the synaptic weights of the neural network to facilitate activity across layers of the neural network.

7. The method of claim 6, wherein the layer-wise scale factors are based on a maximum input to a respective layer of the neural network and a maximum synaptic weight of the respective layer of the neural network.

8. The method of claim 6, wherein transforming the neural network from the synaptic weight-modified SNN to the synaptic weight-modified ANN comprises:
removing the layer-wise scale factors from the neural network; and
replacing the Heaviside function with the original activation function for the neural network.

9. The method of claim 1, wherein modifying the synaptic weights of the neural network by applying the simulated memory replay process to the neural network comprises:
applying a randomly distributed spiking input to the neural network and applying Hebbian-based learning rules to modify the synaptic weights.

10. The method of claim 9, wherein the randomly distributed spiking input comprises a randomly distributed Poisson spiking input reflecting average inputs of a training dataset.

11. The method of claim 9, wherein the Hebbian-based learning rules comprise:
increasing a respective synaptic weight connecting a first neuron to a second neuron when both the first and second neuron are activated, wherein the first neuron is a pre-synaptic connection into the respective synaptic weight and the second neuron is a post-synaptic connection from the respective synaptic weight; and
decreasing the respective synaptic weight when the second neuron is activated and the first neuron is not activated.

12. The method of claim 1, wherein the simulated memory replay process comprises activating an input layer of the neural network with noisy binary inputs.

13. The method of claim 1, wherein the ANN comprises a fully-connected ANN.

14. A system comprising:
one or more processors; and
memory storing machine-readable instructions that, when executed by the one or more processors, cause the system to:
train a neural network with a first portion of data from a dataset, the dataset having a second portion of data that is lost, corrupted, or unusable for training the neural network;
transform the neural network from an artificial neural network (ANN) to a spiking neural network (SNN);
when the neural network is transformed into the SNN, modify synaptic weights of the neural network by applying a simulated memory replay process to the neural network, wherein modifying the synaptic weights of the neural network by applying the simulated memory replay process to the neural network comprises applying a randomly distributed spiking input to the neural network and applying Hebbian-based learning rules to modify the synaptic weights; and
after applying the simulated memory replay process to the neural network, transform the neural network from the synaptic weight-modified SNN to a synaptic weight-modified ANN.

15. The system of claim 14, wherein the randomly distributed spiking input comprises a randomly distributed Poisson spiking input reflecting average inputs of a training dataset.

16. The system of claim 14, wherein the Hebbian-based learning rules comprise:
increasing a respective synaptic weight connecting a first neuron to a second neuron when both the first and second neuron are activated, wherein the first neuron is a pre-synaptic connection into the respective synaptic weight and the second neuron is a post-synaptic connection from the respective synaptic weight; and
decreasing the respective synaptic weight when the second neuron is activated and the first neuron is not activated.

17. The system of claim 14, wherein transforming the neural network from the ANN to the SNN comprises replacing an original activation function of the neural network with a Heaviside function.

18. The system of claim 17, wherein transforming the neural network from the ANN to the SNN further comprises applying layer-wise scale factors to the synaptic weights of the neural network to facilitate activity across layers of the neural network.

19. The system of claim 18, wherein the layer-wise scale factors are based on a maximum input to a respective layer of the neural network and a maximum synaptic weight of the respective layer of the neural network.

20. A method for increasing accuracy of a neural network trained with a portion of data from a dataset or with an imbalanced dataset, the method comprising:
transforming a fully-connected artificial neural network (FCANN) to a spiking neural network (SNN);
modifying synaptic weights of the SNN by applying a simulated memory replay process to the SNN; and
after applying the simulated memory replay process to the SNN, transforming the synaptic weight-modified SNN to a synaptic weight-modified ANN.
